(19) United States
(12) Patent Application Publication
(10) Pub. No.: US 2017/0021205 A1
(43) Pub. Date: Jan. 26, 2017

(54) CONTAINMENT DEVICE

(71) Applicant: John Delatorre, Suglar Land, TX (US)

(72) Inventor: John Delatorre, Suglar Land, TX (US)

(21) Appl. No.: 15/218,763

(22) Filed: Jul. 25, 2016

Related U.S. Application Data
(60) Provisional application No. 62/195,893, filed on Jul. 23, 2015.

(51) Int. Cl. A62B 23/02; B01D 46/02; A41D 13/11; B01D 46/00

(52) U.S. Cl. CPC A62B 23/025; B01D 46/0091; B01D 46/02; A41D 13/11

(57) ABSTRACT

An exemplary embodiment of a folding filtered contamination containment device, in accordance with an embodiment of the present invention. In the present embodiment a folding filtered contamination containment device may be configured to include a filter holder, a filter and a cup, wherein a user may hold the cup to the user's face and cough and/or sneeze into cup. In many embodiments the folding filtered contamination containment device may be configured to be disposable. In some other embodiments the folding filtered contamination containment device may be configured to be reusable and/or washable.

### CROSS-REFERENCE TO RELATED APPLICATIONS

The present Utility patent application claims priority benefit of the [U.S. provisional application for patent Ser. No. 62/195,893 entitled “FOLDING FILTERED CONTAMINATION CONTAINMENT DEVICE”, filed on 2015 Jul. 23 under 35 U.S.C. 119(e). The contents of this related provisional application are incorporated herein by reference for all purposes to the extent that such subject matter is not inconsistent herewith or limiting hereof.]

### FEDERALLY SPONSORED RESEARCH OR DEVELOPMENT

Not applicable.

### REFERENCE TO SEQUENCE LISTING, A TABLE, OR A COMPUTER LISTING APPENDIX

Not applicable.

### COPYRIGHT NOTICE

A portion of the disclosure of this patent document contains material that is subject to copyright protection by the author thereof. The copyright owner has no objection to the facsimile reproduction by anyone of the patent document or patent disclosure for the purposes of referencing as patent prior art, as it appears in the Patent and Trademark Office, patent file or records, but otherwise reserves all copyright rights whatsoever.

### BACKGROUND OF THE RELEVANT PRIOR ART

One or more embodiments of the invention generally relate to a containment device. More particularly, certain embodiments of the invention relates to a contamination containment device.

The following background information may present examples of specific aspects of the prior art (e.g., without limitation, approaches, facts, or common wisdom) that, while expected to be helpful to further educate the reader as to additional aspects of the prior art, is not to be construed as limiting the present invention, or any embodiments thereof, to anything stated or implied therein or inferred thereupon. It may be contemplated that disease control and prevention may be a significant concern to a human population. For example, cold and flu season may be a time of year when a chance of getting sick dramatically increases. It may be further contemplated that people may try various kinds of techniques of avoiding germs and contamination, such as, wearing gloves, washing hands, using tissue, and avoiding sick people. Typically, germs and viruses may sit on objects for long periods of time. Much of the germs and viruses may be airborne and too often may be unavoidable. Much of these germs and viruses may be emitted from coughing and sneezing. It may be believed that young children may quite often be the leading transmitters of germs and viruses since they may touch many objects they may come into contact with. Once a sick child may touch his/her eyes, nose, or mouth, it may further be contemplated that the sick child may touch many more objects and thus may spread contamination. For example, other children may come into contact with the germs and viruses and the contamination may spread from schools, to homes, and eventually places of work. Generally, health officials may instruct the population of conventional containment techniques such as, washing hands after coughing and sneezing in an effort to avoid spreading germs and viruses. It may be contemplated however, that a significant portion of the population may not comply with these instructions and/or may not know how to comply with these instructions.

It is believed that the spread of germs and viruses may be changing. Strains of germs and viruses may exist that may be immune to antibiotics. Furthermore, it may be contemplated that more and more people may be traveling around the world, and thus germs and viruses, possibly being carried by traveling people, may be traveling around the world also. The following is an example of a specific aspect in the prior art that, while expected to be helpful to further educate the reader as to additional aspects of the prior art, is not to be construed as limiting the present invention, or any embodiments thereof, to anything stated or implied therein or inferred thereupon. By way of educational background, another aspect of the prior art generally useful to be aware of is that some further conventional containment techniques may include sneezing or coughing into tissue or covering a face with hands, coughing and sneezing into shirt sleeves, and/or wearing a mask, such as those worn by construction workers, or those used by nurses and doctors during surgery.

In view of the foregoing, it is clear that these traditional techniques are not perfect and leave room for more optimal approaches.

### BRIEF DESCRIPTION OF THE DRAWINGS

The present invention is illustrated by way of example, and not by way of limitation, in the figures of the accompanying drawings and in which like reference numerals refer to similar elements and in which:

FIG. 1 illustrates an exemplary view of an exemplary embodiment of a folding filtered contamination containment device, in accordance with an embodiment of the present invention;

FIG. 2 illustrates exemplary components of an exemplary embodiment of a folding filtered contamination containment device, in accordance with an embodiment of the present invention;

FIG. 3 illustrates a top cross-sectional view of an exemplary filter holder of an exemplary folding filtered contamination containment device embodiment, in accordance with an embodiment of the present invention;

FIG. 4 illustrates a top cross-sectional view of an exemplary embodiment of a cup used in an exemplary folding filtered contamination containment device embodiment, in accordance with an embodiment of the present invention;

FIG. 5 illustrates a side cross-sectional view of an exemplary blank used for a cup, in accordance with an embodiment of the present invention;

FIG. 6 illustrates an exemplary filter top layer, in accordance with an embodiment of the present invention;

FIG. 7 illustrates an exemplary filter bottom layer, in accordance with an embodiment of the present invention;

FIG. 8 illustrates an exemplary configuration of an exemplary filter top layer and an exemplary filter bottom layer, in accordance with an embodiment of the present invention;

FIG. 9 illustrates a bottom view of an exemplary embodiment of a filter holder, in accordance with an embodiment of the present invention.

FIG. 10 illustrates a top view of an exemplary configuration of an exemplary filter and an exemplary filter holder of a folding filtered contamination containment device embodiment, in accordance with an embodiment of the present invention;

FIG. 11 illustrates a top view of an exemplary cup configuration of a folding filtered contamination containment device embodiment, in accordance with an embodiment of the present invention;

FIG. 12 illustrates a bottom view of an exemplary configuration of an exemplary filter and an exemplary filter holder of a folding filtered contamination containment device embodiment, in accordance with an embodiment of the present invention;

FIG. 13 illustrates an exemplary, without limitation, configuration of an exemplary filter holder and an exemplary filter of a folding filtered contamination containment device embodiment, in accordance with an embodiment of the present invention;

FIG. 14 illustrates another exemplary, without limitation, configuration of an exemplary a filter holder and an exemplary filter of a folding filtered contamination containment device embodiment, in accordance with an embodiment of the present invention;

FIG. 15 illustrates another exemplary, without limitation, configuration of an exemplary filter holder and an exemplary filter of a folding filtered contamination containment device embodiment, in accordance with an embodiment of the present invention;

FIG. 16 illustrates another exemplary, without limitation, configuration of an exemplary filter holder and an exemplary filter of a folding filtered contamination containment device embodiment, in accordance with an embodiment of the present invention;

FIG. 17 illustrates an oblique view of an exemplary configuration of a folding filtered contamination containment device embodiment, in accordance with an embodiment of the present invention;

FIG. 18 illustrates an oblique view of an exemplary configuration of an embodiment of a folding filtered contamination containment device, in accordance with an embodiment of the present invention;

FIG. 19 illustrates an oblique view of another exemplary configuration of an embodiment of a folding filtered contamination containment device, in accordance with an embodiment of the present invention;

FIG. 20 illustrates a top view of an exemplary configuration of an embodiment of a folding filtered contamination containment device, in accordance with an embodiment of the present invention;

FIG. 21 illustrates a top view of another exemplary configuration of an embodiment of a folding filtered contamination containment device, in accordance with an embodiment of the present invention;

FIG. 22 illustrates a top view of another exemplary configuration of an embodiment of a folding filtered contamination containment device, in accordance with an embodiment of the present invention;

FIG. 23 illustrates a top view of another exemplary configuration of an embodiment of a folding filtered contamination containment device, in accordance with an embodiment of the present invention;

FIG. 24 illustrates a top view of another exemplary configuration of an embodiment of a folding filtered contamination containment device, in accordance with an embodiment of the present invention;

FIG. 25 illustrates a side view of an exemplary configuration of an exemplary filter and an exemplary filter holder, in accordance with an embodiment of the present invention;

FIG. 26 illustrates a front perspective view of an exemplary application of an exemplary folding filtered contamination containment device embodiment, in accordance with an embodiment of the present invention;

FIG. 27 illustrates a right perspective view of an exemplary application of an exemplary folding filtered contamination containment device embodiment, in accordance with an embodiment of the present invention;

FIG. 28 illustrates a left perspective view of an exemplary application of an exemplary folding filtered contamination containment device embodiment, in accordance with an embodiment of the present invention;

FIG. 29 illustrates a top perspective view of an exemplary application of an exemplary folding filtered contamination containment device embodiment, in accordance with an embodiment of the present invention;

FIG. 30 illustrates a top view of an exemplary configuration of an embodiment of a folding filtered contamination containment device, in accordance with an embodiment of the present invention;

FIG. 31 illustrates a top view of another exemplary configuration of an embodiment of a folding filtered contamination containment device, in accordance with an embodiment of the present invention;

FIG. 32 illustrates a side view of another exemplary configuration of an embodiment of a folding filtered contamination containment device, in accordance with an embodiment of the present invention;

FIG. 33 illustrates a top view of an exemplary closed configuration of an embodiment of a folding filtered contamination containment device, in accordance with an embodiment of the present invention;

FIG. 34 illustrates a top view of an exemplary embodiment of a filter holder, in accordance with an embodiment of the present invention;

FIG. 35 is an oblique view of an exemplary configuration of an exemplary embodiment of a filter holder, in accordance with an embodiment of the present invention;

FIG. 36 is a top view of an exemplary embodiment of a cup of a folding contamination containment device, in accordance with an embodiment of the present invention;

FIG. 37 illustrates a top view of an exemplary configuration of an exemplary embodiment of a folding contamination containment device, in accordance with an embodiment of the present invention;

FIG. 38 illustrates an exemplary view of another exemplary embodiment of a folding filtered contamination containment device, in accordance with an embodiment of the present invention;

FIG. 39 illustrates exemplary components of an exemplary embodiment of a folding filtered contamination containment device, in accordance with an embodiment of the present invention;

FIG. 40 illustrates a top cross-sectional view of an exemplary filter holder of an exemplary folding filtered contamination containment device embodiment, in accordance with an embodiment of the present invention;

FIG. 41 illustrates a bottom view of an exemplary embodiment of a filter holder, in accordance with an embodiment of the present invention;

FIG. 42 illustrates a side view of an exemplary configuration of an exemplary filter and an exemplary filter holder, in accordance with an embodiment of the present invention;

FIG. 43 illustrated a top view of an exemplary configuration of an exemplary filter, in accordance with an embodiment of the present invention;

FIG. 44 illustrates a side view of an exemplary configuration of an exemplary filter and an exemplary filter holder, in accordance with an embodiment of the present invention;

FIG. 45 illustrates a top view of an exemplary configuration of an exemplary filter and an exemplary filter holder, in accordance with an embodiment of the present invention;

FIG. 46 illustrates an exemplary interior view of a folding filtered contamination containment device embodiment, in accordance with an embodiment of the present invention;

FIG. 47 illustrates another exemplary interior view of a folding filtered contamination containment device embodiment, in accordance with an embodiment of the present invention;

FIG. 48 illustrates a side view of an exemplary configuration of a folding filtered contamination containment device embodiment, in accordance with an embodiment of the present invention;

FIG. 49 illustrates a side view of an exemplary closed configuration of a folding filtered contamination containment device embodiment, in accordance with an embodiment of the present invention;

FIG. 50 illustrates a bottom view of an exemplary open configuration of a folding filtered contamination containment device embodiment, in accordance with an embodiment of the present invention;

FIG. 51 illustrates a top view of an exemplary closed configuration of a folding filtered contamination containment device embodiment, in accordance with an embodiment of the present invention;

FIG. 52 illustrates a top view of an exemplary cup configuration of a folding filtered contamination containment device embodiment, in accordance with an embodiment of the present invention;

FIG. 53 illustrates an exemplary top view of an exemplary embodiment of a folding filtered contamination containment device, in accordance with an embodiment of the present invention;

FIG. 54 illustrates an exemplary top view of a user holding an exemplary embodiment of a folding filtered contamination containment device, in accordance with an embodiment of the present invention;

FIG. 55 illustrates an exemplary bottom view of an exemplary cup of a folding filtered contamination containment device embodiment, in accordance with an embodiment of the present invention;

FIG. 56 illustrates a bottom view of an exemplary cup configuration of a folding filtered contamination containment device embodiment, in accordance with an embodiment of the present invention;

FIG. 57 illustrates a bottom view of another exemplary cup configuration of a folding filtered contamination containment device embodiment, in accordance with an embodiment of the present invention;

FIG. 58 illustrates an exemplary application of an embodiment of a folding filtered contamination containment device embodiment, in accordance with an embodiment of the present invention;

FIG. 59 illustrates a left perspective view of an exemplary application of an exemplary folding filtered contamination containment device embodiment, in accordance with an embodiment of the present invention;

FIG. 60 illustrates a front perspective view of an exemplary application of an exemplary folding filtered contamination containment device embodiment, in accordance with an embodiment of the present invention;

FIG. 61 illustrates a bottom view of another embodiment of a folding filtered contamination containment device embodiment, in accordance with an embodiment of the present invention;

FIG. 62 illustrates another exemplary application of another embodiment of an exemplary folding filtered contamination containment device, in accordance with an embodiment of the present invention;

FIG. 63 illustrates a top view of an exemplary closed configuration of another embodiment of a folding filtered contamination containment device, in accordance with an embodiment of the present invention;

FIG. 64 illustrates a side interior view of a configuration of another embodiment of a folding filtered contamination containment device, in accordance with an embodiment of the present invention;

FIG. 65 illustrates a side view of an exemplary closed configuration of another embodiment of a folding filtered contamination containment device, in accordance with an embodiment of the present invention;

FIG. 66 illustrates a side interior view of another configuration of a folding filtered contamination containment device embodiment, in accordance with an embodiment of the present invention.

Unless otherwise indicated illustrations in the figures are not necessarily drawn to scale.

### DETAILED DESCRIPTION OF SOME EMBODIMENTS

The present invention is best understood by reference to the detailed figures and description set forth herein.

Embodiments of the invention are discussed below with reference to the Figures. However, those skilled in the art will readily appreciate that the detailed description given herein with respect to these figures is for explanatory purposes as the invention extends beyond these limited embodiments. For example, it should be appreciated that those skilled in the art will, in light of the teachings of the present invention, recognize a multiplicity of alternate and suitable approaches, depending upon the needs of the particular application, to implement the functionality of any given detail described herein, beyond the particular implementation choices in the following embodiments described and shown. That is, there are modifications and variations of the invention that are too numerous to be listed but that all fit within the scope of the invention. Also, singular words should be read as plural and vice versa and masculine as feminine and vice versa, where appropriate, and alternative embodiments do not necessarily imply that the two are mutually exclusive.

It is to be further understood that the present invention is not limited to the particular methodology, compounds, materials, manufacturing techniques, uses, and applications, described herein, as these may vary. It is also to be understood that the terminology used herein is used for the purpose of describing particular embodiments only, and is not intended to limit the scope of the present invention. It must be noted that as used herein and in the appended claims, the singular forms “a,” “an,” and “the” include the plural reference unless the context clearly dictates otherwise. Thus, for example, a reference to “an element” is a reference to one or more elements and includes equivalents thereof known to those skilled in the art. Similarly, for another example, a reference to “a step” or “a means” is a reference to one or more steps or means and may include sub-steps and subservient means. All conjunctions used are to be understood in the most inclusive sense possible. Thus, the word “or” should be understood as having the definition of a logical “or” rather than that of a logical “exclusive or” unless the context clearly necessitates otherwise. Structures described herein are to be understood also to refer to functional equivalents of such structures. Language that may be construed to express approximation should be so understood unless the context clearly dictates otherwise.

All words of approximation as used in the present disclosure and claims should be construed to mean “approximate,” rather than “perfect,” and may accordingly be employed as a meaningful modifier to any other word, specified parameter, quantity, quality, or concept. Words of approximation, include, yet are not limited to terms such as “substantial”, “nearly”, “almost”, “about”, “generally”, “largely”, “essentially”, “closely approximate”, etc.

As will be established in some detail below, it is well settle law, as early as 1939, that words of approximation are not indefinite in the claims even when such limits are not defined or specified in the specification.

For example, see Ex parte Mallory, 52 USPQ 297, 297 (Pat. Off. Bd. App. 1941) where the court said “The examiner has held that most of the claims are inaccurate because apparently the laminar film will not be entirely eliminated. The claims specify that the film is “substantially” eliminated and for the intended purpose, it is believed that the slight portion of the film which may remain is negligible. We are of the view, therefore, that the claims may be regarded as sufficiently accurate.”

Note that claims need only “reasonably apprise those skilled in the art” as to their scope to satisfy the definiteness requirement. See Energy Absorption Sys., Inc. v. Roadway Safety Servs., Inc., Civ. App. 96-1264, slip op. at 10 (Fed. Cir. Jul. 3, 1997) (unpublished) Hybridtech v. Monoclonal Antibodies, Inc., 802 F.2d 1367, 1385, 231 USPQ 81, 94 (Fed. Cir. 1986), cert. denied, 480 U.S. 947 (1987). In addition, the use of modifiers in the claim, like “generally” and “substantial,” does not by itself render the claims indefinite. See Seattle Box Co. v. Industrial Crating & Packing, Inc., 731 F.2d 818, 828-29, 221 USPQ 568, 575-76 (Fed. Cir. 1984).

Moreover, the ordinary and customary meaning of terms like “substantially” includes “reasonably close to: nearly, almost, about”, connoting a term of approximation. See In re Frye, Appeal No. 2009-006013, 94 USPQ2d 1072, 1077, 2010 WL 889747 (B.P.A.I. 2010) Depending on its usage, the word “substantially” can denote either language of approximation or language of magnitude. Deering Precision Instruments, L.L.C. v. Vector Distribution Sys., Inc., 347 F.3d 1314, 1323 (Fed. Cir. 2003) (recognizing the “dual ordinary meaning of th[e] term [“substantially”] as connoting a term of approximation or a term of magnitude”). Here, when referring to the “substantially halfway” limitation, the Specification uses the word “approximately” as a substitute for the word “substantially” (Fact 4). (Fact 4). The ordinary meaning of “substantially halfway” is thus reasonably close to or nearly at the midpoint between the forwardmost point of the upper or outsole and the rearwardmost point of the upper or outsole.

Similarly, the term ‘substantially’ is well recognize in case law to have the dual ordinary meaning of connoting a term of approximation or a term of magnitude. See Dana Corp. v. American Axle & Manufacturing, Inc., Civ. App. 04-1116, 2004 U.S. App. LEXIS 18265, *13-14 (Fed. Cir. Aug. 27, 2004) (unpublished). The term “substantially” is commonly used by claim drafters to indicate approximation. See Cordis Corp. v. Medtronic AVE Inc., 339 F.3d 1352, 1360 (Fed. Cir. 2003) (“The patents do not set out any numerical standard by which to determine whether the thickness of the wall surface is ‘substantially uniform.’ The term ‘substantially,’ as used in this context, denotes approximation. Thus, the walls must be of largely or approximately uniform thickness.”); see also Deering Precision Instruments, LLC v. Vector Distribution Sys., Inc., 347 F.3d 1314, 1322 (Fed. Cir. 2003); Epcon Gas Sys., Inc. v. Bauer Compressors, Inc., 279 F.3d 1022, 1031 (Fed. Cir. 2002). We find that the term “substantially” was used in just such a manner in the claims of the patents-in-suit: “substantially uniform wall thickness” denotes a wall thickness with approximate uniformity.

It should also be noted that such words of approximation as contemplated in the foregoing clearly limits the scope of claims such as saying ‘generally parallel’ such that the adverb ‘generally’ does not broaden the meaning of parallel. Accordingly, it is well settled that such words of approximation as contemplated in the foregoing (e.g., like the phrase ‘generally parallel’) envisions some amount of deviation from perfection (e.g., not exactly parallel), and that such words of approximation as contemplated in the foregoing are descriptive terms commonly used in patent claims to avoid a strict numerical boundary to the specified parameter. To the extent that the plain language of the claims relying on such words of approximation as contemplated in the foregoing are clear and uncontradicted by anything in the written description herein or the figures thereof, it is improper to rely upon the present written description, the figures, or the prosecution history to add limitations to any of the claim of the present invention with respect to such words of approximation as contemplated in the foregoing. That is, under such circumstances, relying on the written description and prosecution history to reject the ordinary and customary meanings of the words themselves is impermissible. See, for example, Liquid Dynamics Corp. v. Vaughan Co., 355 F.3d 1361, 69 USPQ2d 1595, 1600-01 (Fed. Cir. 2004). The plain language of phrase 2 requires a “substantial helical flow.” The term “substantial” is a meaningful modifier implying “approximate,” rather than “perfect.” In Cordis Corp. v. Medtronic AVE, Inc., 339 F.3d 1352, 1361 (Fed. Cir. 2003), the district court imposed a precise numeric constraint on the term “substantially uniform thickness.” We noted that the proper interpretation of this term was “of largely or approximately uniform thickness” unless something in the prosecution history imposed the “clear and unmistakable disclaimer” needed for narrowing beyond this simple-language interpretation. Id. In Anchor Wall Systems v. Rockwood Retaining Walls, Inc., 340 F.3d 1298, 1311 (Fed. Cir. 2003)” Id. at 1311. Similarly, the plain language of claim 1 requires neither a perfectly helical flow nor a flow that returns precisely to the center after one rotation (a limitation that arises only as a logical consequence of requiring a perfectly helical flow).

The reader should appreciate that case law generally recognizes a dual ordinary meaning of such words of approximation, as contemplated in the foregoing, as connoting a term of approximation or a term of magnitude; e.g., see Deering Precision Instruments, L.L.C. v. Vector Distrib. Sys., Inc., 347 F.3d 1314, 68 USPQ2d 1716, 1721 (Fed. Cir. 2003), cert. denied, 124 S. Ct. 1426 (2004) where the court was asked to construe the meaning of the term “substantially” in a patent claim. Also see Epcon, 279 F.3d at 1031 (“The phrase ‘substantially constant’ denotes language of approximation, while the phrase ‘substantially below’ signifies language of magnitude, i.e., not insubstantial.”). Also, see, e.g., Epcon Gas Sys., Inc. v. Bauer Compressors, Inc., 279 F.3d 1022 (Fed. Cir. 2002) (construing the terms “substantially constant” and “substantially below”); Zodiac Pool Care, Inc. v. Hoffinger Indus., Inc., 206 F.3d 1408 (Fed. Cir. 2000) (construing the term “substantially inward”); York Prods., Inc. v. Cent. Tractor Farm & Family Ctr., 99 F.3d 1568 (Fed. Cir. 1996) (construing the term “substantially the entire height thereof”); Tex. Instruments Inc. v. Cypress Semiconductor Corp., 90 F.3d 1558 (Fed. Cir. 1996) (construing the term “substantially in the common plane”). In conducting their analysis, the court instructed to begin with the ordinary meaning of the claim terms to one of ordinary skill in the art. Prima Tek, 318 F.3d at 1148. Reference to dictionaries and our cases indicates that the term “substantially” has numerous ordinary meanings. As the district court stated, “substantially” can mean “significantly” or “considerably.” The term “substantially” can also mean “largely” or “essentially.” Webster's New 20th Century Dictionary 1817 (1983).

Words of approximation, as contemplated in the foregoing, may also be used in phrases establishing approximate ranges or limits, where the end points are inclusive and approximate, not perfect; e.g., see AK Steel Corp. v. Sollac, 344 F.3d 1234, 68 USPQ2d 1280, 1285 (Fed. Cir. 2003) where it where the court said [W]e conclude that the ordinary meaning of the phrase “up to about 10%” includes the “about 10%” endpoint. As pointed out by AK Steel, when an object of the preposition “up to” is nonnumeric, the most natural meaning is to exclude the object (e.g., painting the wall up to the door). On the other hand, as pointed out by Sollac, when the object is a numerical limit, the normal meaning is to include that upper numerical limit (e.g., counting up to ten, seating capacity for up to seven passengers). Because we have here a numerical limit—“about 10%”—the ordinary meaning is that that endpoint is included.

In the present specification and claims, a goal of employment of such words of approximation, as contemplated in the foregoing, is to avoid a strict numerical boundary to the modified specified parameter, as sanctioned by Pall Corp. v. Micron Separations, Inc., 66 F.3d 1211, 1217, 36 USPQ2d 1225, 1229 (Fed. Cir. 1995) where it states “It is well established that when the term “substantially” serves reasonably to describe the subject matter so that its scope would be understood by persons in the field of the invention, and to distinguish the claimed subject matter from the prior art, it is not indefinite.” Likewise see Verve LLC v. Crane Cams Inc., 311 F.3d 1116, 65 USPQ2d 1051, 1054 (Fed. Cir. 2002). Expressions such as “substantially” are used in patent documents when warranted by the nature of the invention, in order to accommodate the minor variations that may be appropriate to secure the invention. Such usage may well satisfy the charge to “particularly point out and distinctly claim” the invention, 35 U.S.C. §112, and indeed may be necessary in order to provide the inventor with the benefit of his invention. In Andrew Corp. v. Gabriel Elecs. Inc., 847 F.2d 819, 821-22, 6 USPQ2d 2010, 2013 (Fed. Cir. 1988) the court explained that usages such as “substantially equal” and “closely approximate” may serve to describe the invention with precision appropriate to the technology and without intruding on the prior art. The court again explained in Ecolab Inc. v. Envirochem, Inc., 264 F.3d 1358, 1367, 60 USPQ2d 1173, 1179 (Fed. Cir. 2001) that “like the term ‘about,’ the term ‘substantially’ is a descriptive term commonly used in patent claims to ‘avoid a strict numerical boundary to the specified parameter, see Ecolab Inc. v. Envirochem Inc., 264 F.3d 1358, 60 USPQ2d 1173, 1179 (Fed. Cir. 2001) where the court found that the use of the term “substantially” to modify the term “uniform” does not render this phrase so unclear such that there is no means by which to ascertain the claim scope.

Similarly, other courts have noted that like the term “about,” the term “substantially” is a descriptive term commonly used in patent claims to “avoid a strict numerical boundary to the specified parameter.”; e.g., see Pall Corp. v. Micron Seps., 66 F.3d 1211, 1217, 36 USPQ2d 1225, 1229 (Fed. Cir. 1995); see, e.g., Andrew Corp. v. Gabriel Elecs. Inc., 847 F.2d 819, 821-22, 6 USPQ2d 2010, 2013 (Fed. Cir. 1988) (noting that terms such as “approach each other,” “close to,” “substantially equal,” and “closely approximate” are ubiquitously used in patent claims and that such usages, when serving reasonably to describe the claimed subject matter to those of skill in the field of the invention, and to distinguish the claimed subject matter from the prior art, have been accepted in patent examination and upheld by the courts). In this case, “substantially” avoids the strict 100% nonuniformity boundary.

Indeed, the foregoing sanctioning of such words of approximation, as contemplated in the foregoing, has been established as early as 1939, see Ex parte Mallory, 52 USPQ 297, 297 (Pat. Off. Bd. App. 1941) where, for example, the court said “the claims specify that the film is “substantially” eliminated and for the intended purpose, it is believed that the slight portion of the film which may remain is negligible. We are of the view, therefore, that the claims may be regarded as sufficiently accurate.” Similarly, In re Hutchison, 104 F.2d 829, 42 USPQ 90, 93 (C.C.P.A. 1939) the court said “It is realized that “substantial distance” is a relative and somewhat indefinite term, or phrase, but terms and phrases of this character are not uncommon in patents in cases where, according to the art involved, the meaning can be determined with reasonable clearness.”

Hence, for at least the forgoing reason, Applicants submit that it is improper for any examiner to hold as indefinite any claims of the present patent that employ any words of approximation.

Unless defined otherwise, all technical and scientific terms used herein have the same meanings as commonly understood by one of ordinary skill in the art to which this invention belongs. Preferred methods, techniques, devices, and materials are described, although any methods, techniques, devices, or materials similar or equivalent to those described herein may be used in the practice or testing of the present invention. Structures described herein are to be understood also to refer to functional equivalents of such structures. The present invention will be described in detail below with reference to embodiments thereof as illustrated in the accompanying drawings.

References to a “device,” an “apparatus,” a “system,” etc., in the preamble of a claim should be construed broadly to mean “any structure meeting the claim terms” exempt for any specific structure(s)/type(s) that has/(have) been explicitly disavowed or excluded or admitted/implied as prior art in the present specification or incapable of enabling an object/aspect/goal of the invention. Furthermore, where the present specification discloses an object, aspect, function, goal, result, or advantage of the invention that a specific prior art structure and/or method step is similarly capable of performing yet in a very different way, the present invention disclosure is intended to and shall also implicitly include and cover additional corresponding alternative embodiments that are otherwise identical to that explicitly disclosed except that they exclude such prior art structure(s)/step(s), and shall accordingly be deemed as providing sufficient disclosure to support a corresponding negative limitation in a claim claiming such alternative embodiment(s), which exclude such very different prior art structure(s)/step(s) way(s).

From reading the present disclosure, other variations and modifications will be apparent to persons skilled in the art. Such variations and modifications may involve equivalent and other features which are already known in the art, and which may be used instead of or in addition to features already described herein.

Although Claims have been formulated in this Application to particular combinations of features, it should be understood that the scope of the disclosure of the present invention also includes any novel feature or any novel combination of features disclosed herein either explicitly or implicitly or any generalization thereof, whether or not it relates to the same invention as presently claimed in any Claim and whether or not it mitigates any or all of the same technical problems as does the present invention.

Features which are described in the context of separate embodiments may also be provided in combination in a single embodiment. Conversely, various features which are, for brevity, described in the context of a single embodiment, may also be provided separately or in any suitable subcombination. The Applicants hereby give notice that new Claims may be formulated to such features and/or combinations of such features during the prosecution of the present Application or of any further Application derived therefrom.

References to “one embodiment,” “an embodiment,” “example embodiment,” “various embodiments,” “some embodiments,” “embodiments of the invention,” etc., may indicate that the embodiment(s) of the invention so described may include a particular feature, structure, or characteristic, but not every possible embodiment of the invention necessarily includes the particular feature, structure, or characteristic. Further, repeated use of the phrase “in one embodiment,” or “in an exemplary embodiment,” “an embodiment,” do not necessarily refer to the same embodiment, although they may. Moreover, any use of phrases like “embodiments” in connection with “the invention” are never meant to characterize that all embodiments of the invention must include the particular feature, structure, or characteristic, and should instead be understood to mean “at least some embodiments of the invention” includes the stated particular feature, structure, or characteristic.

References to “user”, or any similar term, as used herein, may mean a human or non-human user thereof. Moreover, “user”, or any similar term, as used herein, unless expressly stipulated otherwise, is contemplated to mean users at any stage of the usage process, to include, without limitation, direct user(s), intermediate user(s), indirect user(s), and end user(s). The meaning of “user”, or any similar term, as used herein, should not be otherwise inferred or induced by any pattern(s) of description, embodiments, examples, or referenced prior-art that may (or may not) be provided in the present patent.

References to “end user”, or any similar term, as used herein, is generally intended to mean late stage user(s) as opposed to early stage user(s). Hence, it is contemplated that there may be a multiplicity of different types of “end user” near the end stage of the usage process. Where applicable, especially with respect to distribution channels of embodiments of the invention comprising consumed retail products/services thereof (as opposed to sellers/vendors or Original Equipment Manufacturers), examples of an “end user” may include, without limitation, a “consumer”, “buyer”, “customer”, “purchaser”, “shopper”, “enjoyer”, “viewer”, or individual person or non-human thing benefiting in any way, directly or indirectly, from use of. or interaction, with some aspect of the present invention.

In some situations, some embodiments of the present invention may provide beneficial usage to more than one stage or type of usage in the foregoing usage process. In such cases where multiple embodiments targeting various stages of the usage process are described, references to “end user”, or any similar term, as used therein, are generally intended to not include the user that is the furthest removed, in the foregoing usage process, from the final user therein of an embodiment of the present invention.

Where applicable, especially with respect to retail distribution channels of embodiments of the invention, intermediate user(s) may include, without limitation, any individual person or non-human thing benefiting in any way, directly or indirectly, from use of, or interaction with, some aspect of the present invention with respect to selling, vending, Original Equipment Manufacturing, marketing, merchandising, distributing, service providing, and the like thereof

References to “person”, “individual”, “human”, “a party”, “animal”, “creature”, or any similar term, as used herein, even if the context or particular embodiment implies living user, maker, or participant, it should be understood that such characterizations are sole by way of example, and not limitation, in that it is contemplated that any such usage, making, or participation by a living entity in connection with making, using, and/or participating, in any way, with embodiments of the present invention may be substituted by such similar performed by a suitably configured non-living entity, to include, without limitation, automated machines, robots, humanoids, computational systems, information processing systems, artificially intelligent systems, and the like. It is further contemplated that those skilled in the art will readily recognize the practical situations where such living makers, users, and/or participants with embodiments of the present invention may be in whole, or in part, replaced with such non-living makers, users, and/or participants with embodiments of the present invention. Likewise, when those skilled in the art identify such practical situations where such living makers, users, and/or participants with embodiments of the present invention may be in whole, or in part, replaced with such non-living makers, it will be readily apparent in light of the teachings of the present invention how to adapt the described embodiments to be suitable for such non-living makers, users, and/or participants with embodiments of the present invention. Thus, the invention is thus to also cover all such modifications, equivalents, and alternatives falling within the spirit and scope of such adaptations and modifications, at least in part, for such non-living entities.

Headings provided herein are for convenience and are not to be taken as limiting the disclosure in any way.

The enumerated listing of items does not imply that any or all of the items are mutually exclusive, unless expressly specified otherwise.

It is understood that the use of specific component, device and/or parameter names are for example only and not meant to imply any limitations on the invention. The invention may thus be implemented with different nomenclature/terminology utilized to describe the mechanisms/units/structures/components/devices/parameters herein, without limitation. Each term utilized herein is to be given its broadest interpretation given the context in which that term is utilized.

Terminology. The following paragraphs provide definitions and/or context for terms found in this disclosure (including the appended claims):

“Comprising.” This term is open-ended. As used in the appended claims, this term does not foreclose additional structure or steps. Consider a claim that recites: “A memory controller comprising a system cache . . . .” Such a claim does not foreclose the memory controller from including additional components (e.g., a memory channel unit, a switch).

“Configured To.” Various units, circuits, or other components may be described or claimed as “configured to” perform a task or tasks. In such contexts, “configured to” or “operable for” is used to connote structure by indicating that the mechanisms/units/circuits/components include structure (e.g., circuitry and/or mechanisms) that performs the task or tasks during operation. As such, the mechanisms/unit/circuit/component can be said to be configured to (or be operable) for perform(ing) the task even when the specified mechanisms/unit/circuit/component is not currently operational (e.g., is not on). The mechanisms/units/circuits/components used with the “configured to” or “operable for” language include hardware—for example, mechanisms, structures, electronics, circuits, memory storing program instructions executable to implement the operation, etc. Reciting that a mechanism/unit/circuit/component is “configured to” or “operable for” perform(ing) one or more tasks is expressly intended not to invoke 35 U.S.C. .sctn. 112, sixth paragraph, for that mechanism/unit/circuit/component. “Configured to” may also include adapting a manufacturing process to fabricate devices or components that are adapted to implement or perform one or more tasks.

“Based On.” As used herein, this term is used to describe one or more factors that affect a determination. This term does not foreclose additional factors that may affect a determination. That is, a determination may be solely based on those factors or based, at least in part, on those factors. Consider the phrase “determine A based on B.” While B may be a factor that affects the determination of A, such a phrase does not foreclose the determination of A from also being based on C. In other instances, A may be determined based solely on B.

The terms “a”, “an” and “the” mean “one or more”, unless expressly specified otherwise.

Unless otherwise indicated, all numbers expressing conditions, concentrations, dimensions, and so forth used in the specification and claims are to be understood as being modified in all instances by the term “about.” Accordingly, unless indicated to the contrary, the numerical parameters set forth in the following specification and attached claims are approximations that may vary depending at least upon a specific analytical technique.

The term “comprising,” which is synonymous with “including,” “containing,” or “characterized by” is inclusive or open-ended and does not exclude additional, unrecited elements or method steps. “Comprising” is a term of art used in claim language which means that the named claim elements are essential, but other claim elements may be added and still form a construct within the scope of the claim.

As used herein, the phase “consisting of” excludes any element, step, or ingredient not specified in the claim. When the phrase “consists of” (or variations thereof) appears in a clause of the body of a claim, rather than immediately following the preamble, it limits only the element set forth in that clause; other elements are not excluded from the claim as a whole. As used herein, the phase “consisting essentially of” and “consisting of” limits the scope of a claim to the specified elements or method steps, plus those that do not materially affect the basis and novel characteristic(s) of the claimed subject matter (see Norian Corp. v Stryker Corp., 363 F.3d 1321, 1331-32, 70 USPQ2d 1508, Fed. Cir. 2004). Moreover, for any claim of the present invention which claims an embodiment “consisting essentially of” or “consisting of” a certain set of elements of any herein described embodiment it shall be understood as obvious by those skilled in the art that the present invention also covers all possible varying scope variants of any described embodiment(s) that are each exclusively (i.e., “consisting essentially of”) functional subsets or functional combination thereof such that each of these plurality of exclusive varying scope variants each consists essentially of any functional subset(s) and/or functional combination(s) of any set of elements of any described embodiment(s) to the exclusion of any others not set forth therein. That is, it is contemplated that it will be obvious to those skilled how to create a multiplicity of alternate embodiments of the present invention that simply consisting essentially of a certain functional combination of elements of any described embodiment(s) to the exclusion of any others not set forth therein, and the invention thus covers all such exclusive embodiments as if they were each described herein.

With respect to the terms “comprising,” “consisting of,” and “consisting essentially of,” where one of these three terms is used herein, the presently disclosed and claimed subject matter may include the use of either of the other two terms. Thus in some embodiments not otherwise explicitly recited, any instance of “comprising” may be replaced by “consisting of” or, alternatively, by “consisting essentially of”, and thus, for the purposes of claim support and construction for “consisting of” format claims, such replacements operate to create yet other alternative embodiments “consisting essentially of” only the elements recited in the original “comprising” embodiment to the exclusion of all other elements.

Devices or system modules that are in at least general communication with each other need not be in continuous communication with each other, unless expressly specified otherwise. In addition, devices or system modules that are in at least general communication with each other may communicate directly or indirectly through one or more intermediaries.

A description of an embodiment with several components in communication with each other does not imply that all such components are required. On the contrary a variety of optional components are described to illustrate the wide variety of possible embodiments of the present invention.

As is well known to those skilled in the art many careful considerations and compromises typically must be made when designing for the optimal manufacture of a commercial implementation any system, and in particular, the embodiments of the present invention. A commercial implementation in accordance with the spirit and teachings of the present invention may configured according to the needs of the particular application, whereby any aspect(s), feature(s), function(s), result(s), component(s), approach(es), or step(s) of the teachings related to any described embodiment of the present invention may be suitably omitted, included, adapted, mixed and matched, or improved and/or optimized by those skilled in the art, using their average skills and known techniques, to achieve the desired implementation that addresses the needs of the particular application.

It is to be understood that any exact measurements/dimensions or particular construction materials indicated herein are solely provided as examples of suitable configurations and are not intended to be limiting in any way. Depending on the needs of the particular application, those skilled in the art will readily recognize, in light of the following teachings, a multiplicity of suitable alternative implementation details.

It may be contemplated that how the general public behaves when coughing and sneezing has not changed over many years. It may further be contemplated that behavior has not changed because a simple, low cost, socially and culturally acceptable device has yet to be introduced into the marketplace.

It is believed that a device to possibly control the spread of germs and viruses during coughing and sneezing may be needed. Manufacturers and marketing experts may contemplate that an optimal application of the device may include being immediately and easily understood by the general public. Furthermore, it may be contemplated that possibly achieving widespread change in human behavior may not be easy but to attempt to do so may involve a device that may be relatively easy to understand, relatively inexpensive, and relatively acceptable socially and culturally.

It may be contemplated that people may typically use devices, such as coffee cups often. It may be further contemplated and estimated that billions of times each day, people may raise coffee cups to their mouths, moreover, raising a coffee cup may not be much different than a person raising their hands to cover up a cough. Therefore, it may be contemplated that the public may understand low costs and benefits of a cup device, furthermore, it is believed the public may easily accept using a cup device.

Therefore, what may be needed to possibly control the spread of germs and viruses may be a folding filtration device that may make it easier for people to carry so they may be able to capture their germs and viruses when coughing and sneezing so they may not spread them to others or to nearby objects, such as, and without limitation, phones, computer keyboards, school desks and the like.

As will be described in some detail below, in many embodiments of the present invention, a folding filtered contamination containment device may be used for filtering germs and viruses expelled from a user during coughing and sneezing. In many embodiments the device may be used as a filter in a cup, wherein the cup may be foldable, portable and hand held, replacing use of a user's hand, arm, shirt sleeve, tissue or some other means of catching germs and viruses when coughing and sneezing. In some embodiments the filter may be placed within the cup possibly making the device safe for others to potentially hold or transport after the device may have been used. For example, a child may be able to use the cup and when done may hand the cup to a parent without the parent potentially becoming contaminated. In some other embodiments, the cup may be disposable or made to be washed and reused. In yet some other embodiments the filter may be used by a user without being placed within a cup.

In many embodiments of the present invention, a folding filtered contamination containment device may be held by a hand of a user to the user's nose and mouth, at least when the user may be coughing and/or sneezing. In many embodiments, a die cut blank material may be used to form a cup, wherein the cup may include no bottom. In some embodiments, a material of the cup may be paper, plastic, some other suitable material for the needs of a particular application, or a combination thereof. In many embodiments a filter may be joined to a filter holder and both may be inserted into a top opening of the cup. In many embodiments the filter and filter holder may be recessed into the cup and portions of the filter holder may be secured to at least one wall of the cup. In some embodiments a material of the filter holder may be paper, plastic, some other suitable material for the needs of a particular application, or a combination thereof. In some embodiments a material of the filter may be nonwoven polypropylene and spunbond polypropylene, some other suitable material for the needs of a particular application, or a combination thereof. In many embodiments a rim of the cup may have four or more foldout portions. In some embodiments, the foldout portions may be located along a top perimeter of the cup opening and may provide comfort to the user when placing their nose and mouth into an interior top opening of the cup. In many embodiments, the foldout portions may help the user avoid placing their face directly on the rim of the cup. In some embodiments, for possible added comfort, foam pads may be placed on an interior side of the foldout portions of the cup. Moreover, in many embodiments the rim of the cup may include two or more cutout portions, wherein two of the cutout portions may help secure and guide the placement of the filter holder to the rim of the cup. Furthermore, the cutout portions may allow the filter holder to remain at a same height as a top rim of the cup. In some embodiments, possible uneven edges along a rim of the cup may be advantageously eliminated and thus comfort may be improved for the user by having the filter holder and the rim of the cup at the same level across an entire top portion of the cup. In some embodiments, another two cutout portions along a front and a rear of the cup may provide a resting place and guide for a placement of the nose and a chin of the user.

In many embodiments of an exemplary, and without limitation, application of the folding filtered contamination containment device, the top opening of the cup and a bottom opening of the cup may be configured to be a particular shape independently. In some embodiments of the present invention, the particular shape may be oval or generally circular with a pointed front portion and a pointed back portion. The top opening of the cup and a bottom opening of the cup may be flat when folded. In many embodiments, the material of the cup may provide flexibility, and thus the cup may be flexibly designed to allow an expansion and contraction of the top opening of the cup and the bottom opening of the cup. In many applications of the present invention, a user may use their hand to force walls of the cup in or out and thus may allow the top opening of the cup and the bottom opening of the cup to possibly be configured as different sizes respectively. This may provide an advantageous fitting since a human face may be many different shapes and sizes.

In some other embodiments of the present invention, means are provided to perform the foregoing functions. In an embodiment of the present invention, the filter holder and cup may be cooperatively configured together such that portions of the filter holder may be inserted into an interior of the cup. In another embodiment of the present invention, the folding filtered contamination containment device may further include a filter holder with foldout portions that may flex and may be positioned flat and parallel against an interior wall of the cup. In another embodiment of the present invention, the folding filtered contamination containment device may further include score lines to possibly provide a folding of the bottom of the cup so that the cup may stand upright on a table or other surface. In another embodiment of the present invention, the folding filtered contamination containment device may further include a scent tab positioned within an interior portion of a wall of the cup, wherein a scent of the scent tab may approximate a strawberry, lemon, or some other aroma and thus possibly making an exemplary, and without limitation, application of the folding filtered contamination containment device more enjoyable. In another embodiment of the present invention, the folding filtered contamination containment device may include a tissue dispenser removably joined to an exterior or interior wall of the cup. In some other embodiments, the dispenser may be fixed to the interior or the exterior wall the cup. In some embodiments, the dispenser may be a wet wipe packet adhesively joined to a wall of the cup and/or the dispenser may be an opening in the wall of the cup to possibly allow tissues inside the cup to be possibly pulled out. In another embodiment of the present invention, the folding filtered contamination containment device may include a filter attached to the bottom of the cup around a bottom rim of the cup. In some embodiments, the filter attached to the bottom of the cup may be an additional filter and thus may provide a possible dual filtration.

An exemplary, and without limitation, application of the present invention may be to provide some embodiments of the folding filtered contamination containment device to, for example, and without limitation, nursing homes and hospitals where it may be contemplated that many people may be likely to cough and sneeze excessively. Furthermore, another exemplary, and without limitation, application of some embodiments of the folding filtered contamination containment device may include school nurses possibly providing the device to sick children who may be waiting for their parents and the device may help reduce a chance of the parent also getting sick during a drive home. Moreover, a contemplated device application may be to color coordinate the device and thus possibly giving teachers a relatively improved ability of monitoring which students may likely be contagious versus those who may only be suffering from allergies. In some exemplary, and without limitation, applications of embodiments of the folding filtered contamination containment device, disruptions and distractions possibly caused by students being upset from sitting next to coughing and sneezing classmates may be reduced. Furthermore, in a case that the child may be done using the folding filtered contamination containment device for the day, the child may toss the device in the trash.

In many exemplary, and without limitation, applications of embodiments of folding filtered contamination containment device, the device may also lower a volume of noise created from coughing and sneezing by a user's hand and the device both being able to possibly help to muffle sound. In some applications, the device can be a possible tool for teaching, possibly helping students and others learn a single method of controlling germs and viruses. At present, students and others perform many variations of putting their hands and arms to their face in an attempt to control the spread of germs and viruses. It may be contemplated that even in a case that coughing and sneezing may be a result of allergies, an itchy or dry throat, or some other reason, the folding filtered contamination containment device may still help children to be considerate of their fellow classmates. It may be further contemplated that the folding filtered contamination containment device may help teach children what may and may not be socially and culturally acceptable behavior. In many exemplary, and without limitation, applications of embodiments of the present invention, the folding filtered contamination containment device may be used in homes and thus possibly prevent spreading germs and viruses to family members. The spreading of germs and viruses may further be minimized by the device being configured to be disposable. In many embodiments of the present invention, the user's hands may not have to come in contact with an inside of the folding filtered contamination containment device during use. Furthermore, air coming out of the cup, through a bottomless portion may be filtered. In some exemplary, without limitation, applications of embodiments of the present invention the folding filtered contamination containment device may also be placed in doctor's offices and waiting rooms. Moreover, in still yet other exemplary, without limitation, applications, of embodiments of the present invention, the folding filtered contamination containment device may be used in public places such as, and without limitation, parks, on public transportations, in public buildings, at social gathering events, beaches, on private transportation, at private events, and outdoors in general. It may be contemplated that a low cost of the folding filtered contamination containment device may encourage businesses to possibly leave the devices sitting on waiting room tables to be generally used as a courtesy to others.

Other features, advantages, and objects of the present invention may become more apparent and may be more readily understood from the following detailed description, which should be read in conjunction with the accompanying drawings

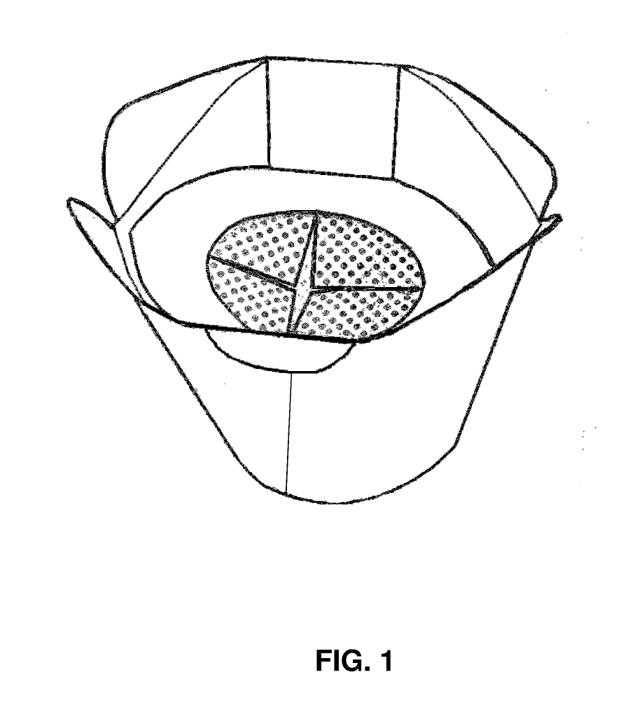

FIG. 1 illustrates an exemplary view of an exemplary embodiment of a folding filtered contamination containment device, in accordance with an embodiment of the present invention. In the present embodiment a folding filtered contamination containment device may be configured to include a filter holder, a filter and a cup, wherein a user may hold the cup to the user's face and cough and/or sneeze into cup. In many embodiments the folding filtered contamination containment device may be configured to be disposable. In some other embodiments the folding filtered contamination containment device may be configured to be reusable and/or washable.

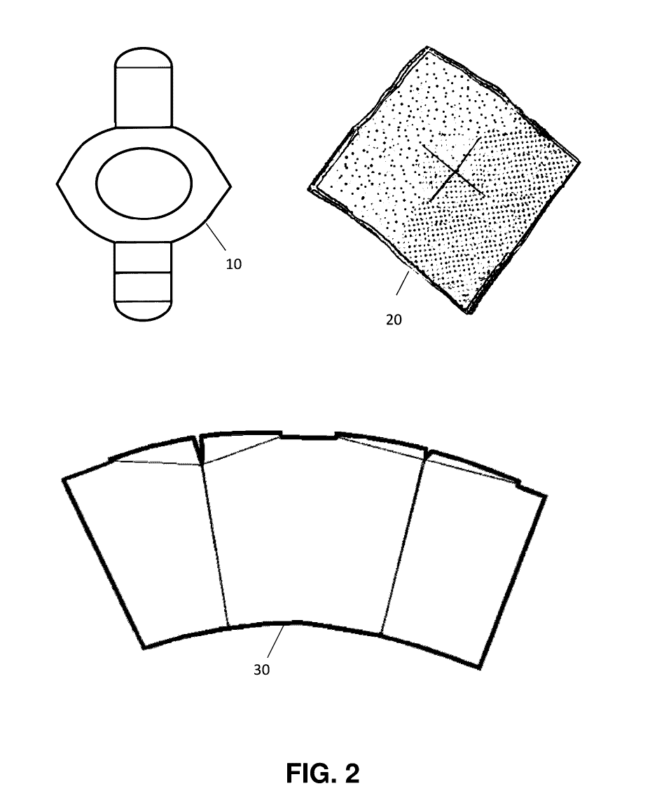

FIG. 2 illustrates exemplary components of an exemplary embodiment of a folding filtered contamination containment device, in accordance with an embodiment of the present invention. In the present embodiment, the folding filtered contamination containment device may include a filter holder 10, a filter 20, and a blank 30. The components may be comprised of a multiplicity of materials such as, and without limitation, paper, plastic, nonwoven fabrics, activated charcoal, cotton, gauze, cellulose acetate fiber, Styrofoam™, chipboard wherein filter holder 10 may be constructed of substantially any durable material that may be imprinted with advertisements or logos, such as, and without limitation, paper, plastic, etc. Filter 20 may be constructed of any durable, flexible material such as, and without limitation, nonwoven fabric, activated charcoal, cotton, gauze, etc. Furthermore, blank 30 may be constructed of any durable material that can be imprinted with advertisements or logos, such as, but not limited to, paper, plastic, etc. In many embodiments of the present invention, filter holder 10 may be comprised of a preferred range of 8-point to 20-point chipboard. Furthermore, filter 20 may include a top layer and a bottom layer, wherein each layer may be comprised of two 3 ply layers of 100% nonwoven polypropylene fabric. In many embodiments, the top layer of filter 20, may further include a meltblown nonwoven layer, with a weight class of 30 gsm, between each 3 ply layer and each 3 ply layer of the bottom layer may be spunbond nonwoven fabric with a weight class of 15 gsm each. The total weight class of filter 20 may be 60 gsm. In many embodiments, filter 20 may be comprised of a preferred range of 1 to 4 ply material. In many embodiments of the present invention, filter 20 may be comprised of a preferred range total weight class of 20 gsm to 100 gsm.] In many embodiments, blank 30 may be comprised of a preferred range of 8-point to 20-point chipboard and also may be configured to be a cup like shape.

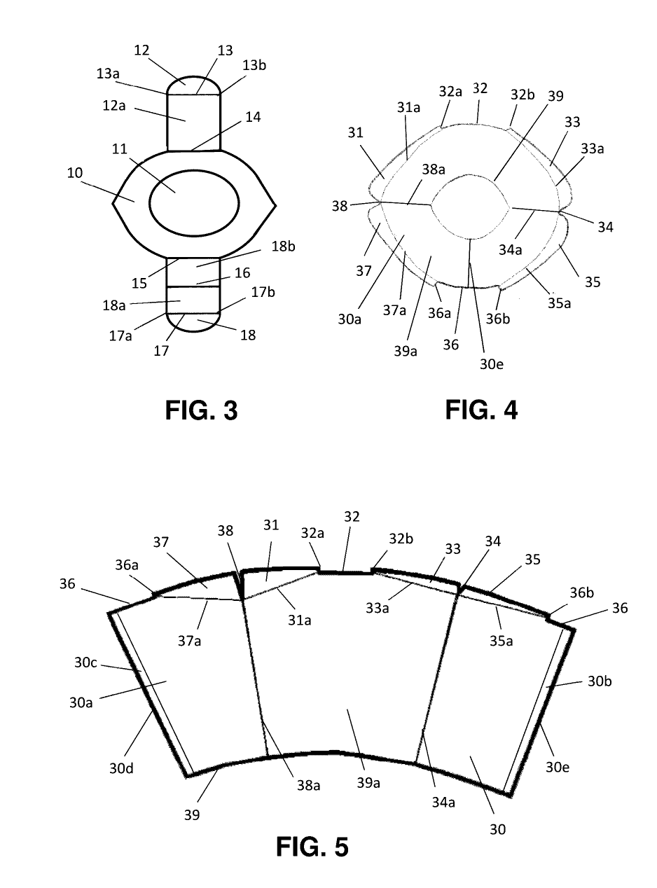

FIG. 3 illustrates a top cross-sectional view of an exemplary filter holder 10 of an exemplary folding filtered contamination containment device embodiment, in accordance with an embodiment of the present invention. In the present embodiment, the filter holder may include a filter holder opening 11, a right tab 12, a tab arm 12a, a score line 13, score line edges 13a and 13b, score lines 14, 15, 16, and 17, score line edges 17a and 17b, a left tab 18 and tab arms 18a and 18b. In the present embodiment, the filter holder may be folded at score lines 13, 14, 15, 16, and 17 possibly allowing filter holder 10 to flex at each score line so that filter holder 10 may be more easily positioned for configuration of the folding filtered contamination containment device. In some embodiments, score lines 14 and 15 may be configured to include cuts into a top surface of the filter holder so that score lines 14 and 15 may allow an upward folding of the tab arm and tab arm 18b furthermore, score lines 13, 16 and 17 may be configured to include cuts into a bottom surface of the filter holder so that score lines 13, 16 and 17 may allow a downward folding of the right tab, the left tab, and tab arm 18a.

FIG. 4 illustrates a top cross-sectional view of an exemplary embodiment of a cup 30a used in an exemplary folding filtered contamination containment device embodiment, in accordance with an embodiment of the present invention. In the present embodiment, and with reference to FIG. 3, the cup may be configured without a lateral bottom portion, furthermore, the cup may include an inside edge 30e, a right cheek foldout 31, a right cheek foldout score line 31a, a right tab rest 32, right tab guides 32a and 32b, a right chin foldout 33, a right chin foldout score line 33a, a chin rest 34, a rear fold score line 34a, a left chin foldout 35, a left chin foldout score line 35a, a left tab rest 36, left tab guides 36a and 36b, left cheek foldout 37, left cheek foldout score line 37a, a nose rest 38, a front fold score line 38a, a cup bottom edge 39 and cup interior wall 39a. In a case that a user may have to cough and/or sneeze, the user may place their mouth and nose into a top opening of cup 30a. The user's chin may be positioned against chin rest 34, their nose may be positioned against nose rest 38, and their cheeks may be positioned against an inside portion of right cheek foldout 31 and an inside portion of right chin foldout 33. Furthermore, the user's chin may be positioned against an interior portion of left chin foldout 35 and an interior portion of left cheek foldout 37. In the present embodiment, score lines 34a and 38a may be configured to include cuts on the cup interior wall to possibly allow bending at score lines 34a and 38a. Furthermore, in the present embodiment, score lines 31a, 33a, 35a and 37a may be cut on an exterior cup wall to possibly allow bending at score lines 31a, 33a, 35a and 37a.

In the present embodiment, cup 30a may be configured to include an adjustable top opening, wherein the top opening may be approximately oval in shape. It may be contemplated that an oval shape may be advantageous for optimally covering a user's nose and mouth. It may further be contemplated that a region encircling a bridge of a person's nose, the person's nostrils, and the person's mouth may be optimally approximated by an oval. In the present embodiment, a user holding cup 30a may add or reduce pressure on walls of the cup and may change the size of the approximately oval shaped top opening to possibly provide a better fit for faces that are different shapes and sizes. Furthermore, it may be contemplated that most adults and children between 8 and 18 years of age may need a cup opening around 76 mm in diameter, while most children under the age of eight may need a cup opening around 58 mm in diameter. In many embodiments, the top opening of cup 30a when in use may measure in a preferred range from 3.2 inches to 4.5 inches in length and 1.25 inches to 3.75 inches in width, moreover, cup 30a when in use may further have a bottom opening that may measure 1.25 inches to 3.00 inches in length and 0.25 inches to 2.50 inches in width. In some embodiments, the top opening of cup 30a may be configured to have an increased semi-maj or axis length by pressing inward against the exterior wall at positions vertically parallel to right tab rest 32 and positions vertically parallel to left tab rest 36. In some embodiments the top opening of cup 30a may also be configured to have an increased semi-minor axis length by pressing against the exterior side of cup 30a along score line 34a and 38a. It may further be contemplated that using a variable size cup opening, for each person, may insure a greater chance that a higher percentage of the aerosol from coughing and sneezing may enter the cup and pass through the filter and out the bottom of the cup.

Furthermore, in many embodiments, filter holder 10 (as illustrated at least in FIG. 3) may be removably joined to cup 30a, wherein right tab guides 32a and 32b may help limit lateral movement of right tab 12 and right arm 12a between score line edges 13a and 13b, moreover, left tab guides 36a and 36b help limit lateral movement of left tab 18 and left arms 18a and 18b between score line edges 17a and 17b.

FIG. 5 illustrates a side cross-sectional view of an exemplary blank 30 used for a cup, in accordance with an embodiment of the present invention. In the present embodiment, and with reference to FIG. 4, blank 30 may include an underlap 30b, an overlap 30c, an outside edge 30d, an inside edge 30e, a right cheek foldout 31, a right cheek foldout score line 31a, a right tab rest 32, right tab guides 32a and 32b, a right chin foldout 33, a right chin foldout score line 33a, a chin rest 34, a rear fold score line 34a, a left chin foldout 35, a left chin foldout score line 35a, a left tab rest 36, left tab guides 36a and 36b, a left cheek foldout 37, a left cheek foldout score line 37a, a nose rest 38, a front fold score line 38a, cup bottom edge 39, and cup interior wall 39a. Furthermore, in the present embodiment blank 30 may be configured to form cup 30a by folding blank 30 along front score line 38a, and folding blank 30 along back score line 34a. Furthermore, underlap 30b may be joined to overlap 30c.

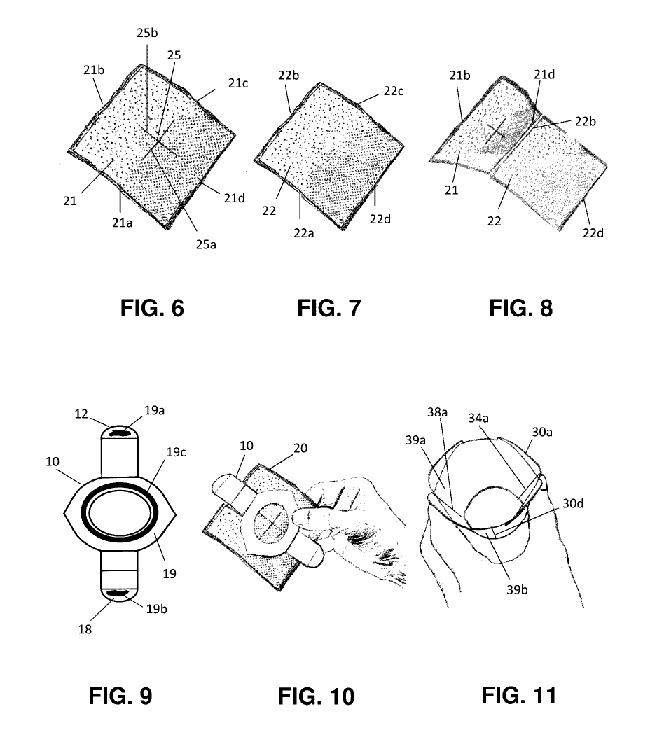

FIG. 6 illustrates an exemplary filter top layer 21, in accordance with an embodiment of the present invention. In the present embodiment, and with reference to FIG. 2, filter 20 may include a filter top layer 21, filter top layer edges 21a, 21b, 21c, & 21d and filter opening at the center of the filter, wherein the filter opening may include a horizontal die cut 25a and vertical die cut 25b. In some suitable implementations, filter top layer 21 may measure 4.25 inches in length and 4.25 inches in width, furthermore, horizontal die cut 25a and vertical die cut 25b each may measure 1.25 inch in length. However, alternate measurements for top filter layer 21, horizontal die cut 25a, and vertical die cut 25b may be suitable depending upon the needs of the particular application. In an alternative embodiment, a filter may include an antibacterial solution. In another alternative embodiment a filter may be scented. In yet another alternative embodiment, a filter may include embedded nanoparticles comprising phospholipids and a chromatic polymer such as, polydiacetylene (PDA), wherein the nanoparticles may go through a fluorescent transformation when in contact with bacteria, and thus may produce a visible chromatic transformation to allow a user to possibly see a color change in response to expelled bacteria during coughing and/or sneezing into the filter.

FIG. 7 illustrates an exemplary filter bottom layer 22, in accordance with an embodiment of the present invention. In the present embodiment, and with reference to FIG. 2, filter 20 may include filter bottom layer 22 filter bottom layer edges 22a, 22b, 22c and 22d. In some suitable implementations, filter bottom layer 22 may measure 4.25 inches in length and 4.25 inches in width. However, alternate measurements for filter bottom layer 22 may be suitable depending upon the needs of the particular application.

FIG. 8 illustrates an exemplary configuration of an exemplary filter top layer 21 and an exemplary filter bottom layer 22, in accordance with an embodiment of the present invention. In the present embodiment, and with reference to FIG. 2, FIG. 6, and FIG. 7, filter 20 may include an entire length of filter top layer edge 21d joined to an entire length of filter bottom layer edge 22b. Furthermore, in the present embodiment, filter 20 may be constructed by bonding filter top layer edges 21a, 21b, 21c, and 21d to filter bottom layer edges 22a, 22b, 22c, and 22d. In some suitable implementations, filter top layer edges 21a, 21b, 21c and 21d may be joined to filter bottom layer edges 22a, 22b, 22c and 22d so that horizontal die cut slit 25a and vertical die cut slit 25b may be the only two relatively large filter openings. However, alternate filter top layer 21 openings may be suitable depending upon the needs of the particular application.

FIG. 9 illustrates a bottom view of an exemplary embodiment of a filter holder 10, in accordance with an embodiment of the present invention. In the present embodiment, a bottom of filter holder 10, may include a filter holder base 19 and adhesive 19a, 19b, and 19c, wherein adhesive 19c may cover a portion of filter holder base 19. In some suitable implementations, adhesive 19c may not cover an entire portion of filter holder base 19 as illustrated by way of example, and without limitation, in FIG. 9. However, alternate patterns of adhesive 19a, 19b and 19c may be suitable depending upon the needs of the particular application.

FIG. 10 illustrates a top view of an exemplary configuration of an exemplary filter 20 and an exemplary filter holder 10 of a folding filtered contamination containment device embodiment, in accordance with an embodiment of the present invention. In the present embodiment, and with reference to FIG. 9, filter holder 10 may be joined to filter 20 by a joining mechanism, wherein the joining mechanism may be the adhesive 19c. In an alternative embodiment, the joining mechanism may be alternative filter layer openings, wherein side portions of filter holder 10 may be threaded though the alternative filter layer openings respectively so that a smaller portion of each side portion may be located underneath a small portion of the filter layer respectively. Furthermore, the side portions of the filter holder may still extend outward with respect to filter 20.

FIG. 11 illustrates a top view of an exemplary cup 30a configuration of a folding filtered contamination containment device embodiment, in accordance with an embodiment of the present invention. In the present embodiment, cup 30a, may include an outside edge 30d, score lines 34a and 38a, interior cup wall 39a, and exterior cup wall 39b, wherein cup 30a may be configured to be lightweight and hand held. In some alternative embodiments, cup 30a may comprise of a stiff, lightweight material such as, and without limitation, Styrofoam™. Furthermore, in some embodiments, cup 30a may be configured to not bend or flex. In yet some other alternative embodiments, a top opening of cup 30a, may be configured to approximate a circle, a circular shape, a rounded shape, a triangle, a square, or substantially any regular or irregular polygonal shape.

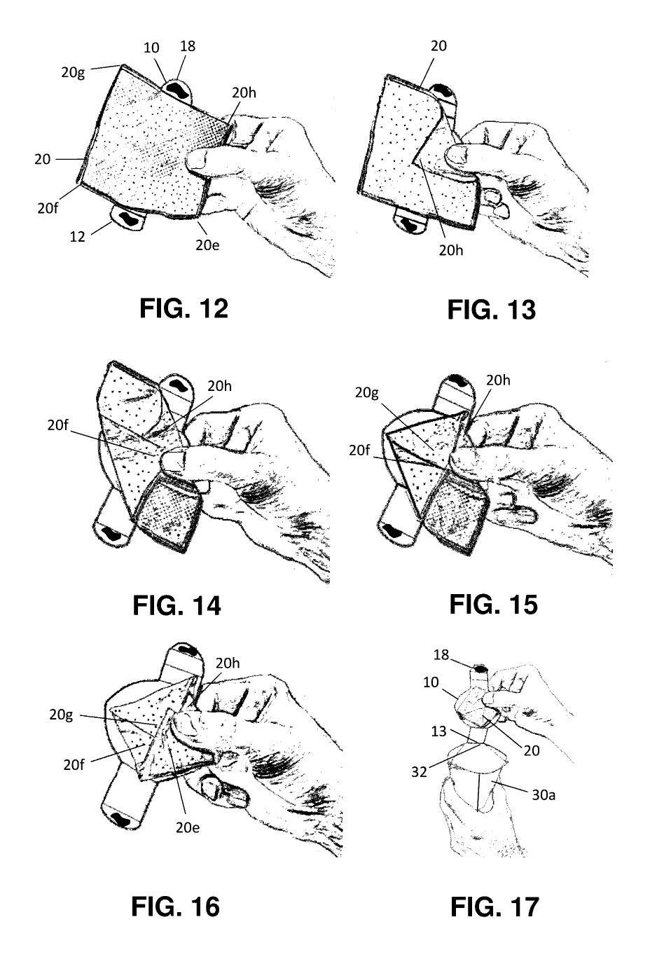

FIG. 12 illustrates a bottom view of an exemplary configuration of an exemplary filter 20 and an exemplary filter holder 10 of a folding filtered contamination containment device embodiment, in accordance with an embodiment of the present invention. In the present embodiment, and with respect to FIG. 11, filter holder 10 may be joined to filter 20 by a joining mechanism, wherein the joining mechanism may be an adhesive. Furthermore, filter 20 may further include filter corners 20e, 20f, 20g and 20h, and filter holder 10 may include right tab 12 and left tab 18, wherein filter corners 20e, 20f, 20g, 20h, right tab 12, and left tab 18 may be utilized to join the filter and filter holder to cup 30a. In the present embodiment, FIG. 13 illustrates an exemplary, without limitation, configuration of an exemplary filter holder and an exemplary filter of a folding filtered contamination containment device embodiment, in accordance with an embodiment of the present invention, wherein the exemplar filter holder may be filter holder 10 and the exemplary filter may be filter 20, and furthermore, filter corner 20h may be folded to a bottom center portion of filter 20. Next, FIG. 14 illustrates another exemplary, without limitation, configuration of an exemplary a filter holder and an exemplary filter of a folding filtered contamination containment device embodiment, in accordance with an embodiment of the present invention, wherein the exemplar filter holder may be filter holder 10 and the exemplary filter may be filter 20, and furthermore, filter corner 20f may be folded over filter corner 20h. Then, FIG. 15 illustrates another exemplary, without limitation, configuration of an exemplary filter holder and an exemplary filter of a folding filtered contamination containment device embodiment, in accordance with an embodiment of the present invention, wherein the exemplar filter holder may be filter holder 10 and the exemplary filter may be filter 20, and furthermore, filter corner 20g may be folded over filter corners 20f, and 20h. Furthermore, FIG. 16 illustrates another exemplary, without limitation, configuration of an exemplary filter holder and an exemplary filter of a folding filtered contamination containment device embodiment, in accordance with an embodiment of the present invention, wherein the exemplar filter holder may be filter holder 10 and the exemplary filter may be filter 20, and furthermore, filter corner 20e may be folded over filter corners 20h, 20f, and 20g. FIG. 17 illustrates an oblique view of an exemplary configuration of a folding filtered contamination containment device embodiment, in accordance with an embodiment of the present invention, wherein score line 13 may be joined to right tab rest 32 which may position filter holder 10, filter 20 and left tab 18 to extended above cup 30a. In some suitable implementations, right tab 12 may be joined to a top of an exterior wall portion of cup 30a. However, other attachment techniques may be suitable depending upon the needs of the particular application.

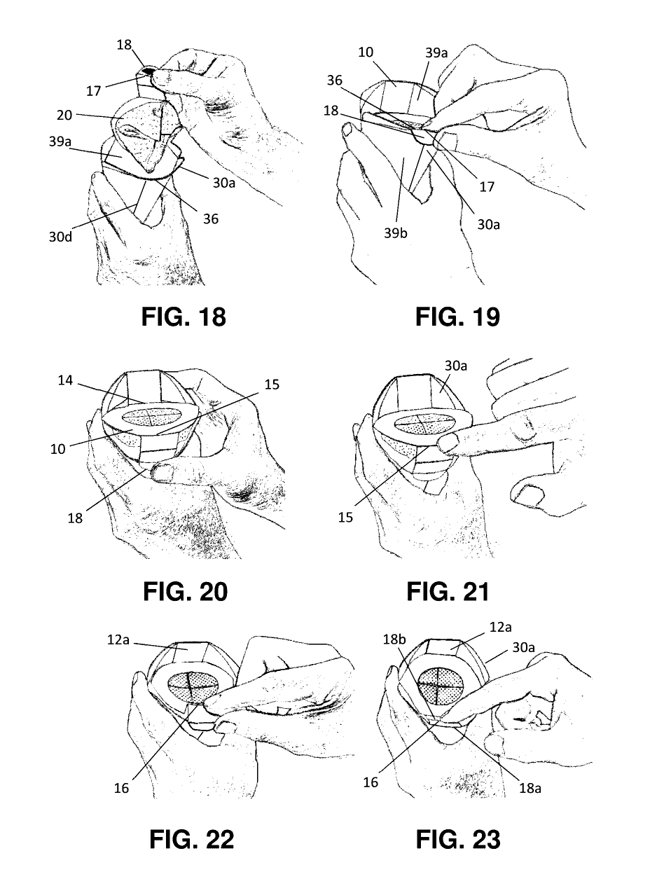

FIG. 18 illustrates an oblique view of an exemplary configuration of an embodiment of a folding filtered contamination containment device, in accordance with an embodiment of the present invention. In the present embodiment, a user may lower filter holder 10 and filter 20 into cup 30a, wherein a user may hold cup 30a with one hand and also hold left tab 18, with another hand to guide filter 20 into cup 30a by guiding left tab 18 toward left tab rest 36.

FIG. 19 illustrates an oblique view of another exemplary configuration of an embodiment of a folding filtered contamination containment device, in accordance with an embodiment of the present invention. In the present embodiment a user may hold a cup of a folding filtered contamination containment device, with one hand and may join left tab 18 to exterior cup wall 39b via left tab rest 36 with another hand, wherein the joining may include bending filter holder 10 at score line 17. Furthermore, in the present embodiment, filter holder 10 may be placed inside cup 30a, wherein a right arm portion of the filter holder may be towards cup interior wall 39a and score line 17 may be positioned on top of left tab rest 36. However, other attachment techniques may be suitable depending upon the needs of the particular application.

FIG. 20 illustrates a top view of an exemplary configuration of an embodiment of a folding filtered contamination containment device, in accordance with an embodiment of the present invention. In the present embodiment, the folding filtered contamination containment device may include, at least, filter holder 10, score line 14, cup 30a, and score line 15, wherein, the filter holder and score line 14 may be recessed inside cup 30a, and score line 15 may extended outside cup 30a.

FIG. 21 illustrates a top view of another exemplary configuration of an embodiment of a folding filtered contamination containment device, in accordance with an embodiment of the present invention, wherein a user may press down on score line 15 to possibly position the filter holder inside cup 30a.

FIG. 22 illustrates a top view of another exemplary configuration of an embodiment of a folding filtered contamination containment device, in accordance with an embodiment of the present invention, wherein a user may press down on score line 16 to further possibly position the filter holder inside the cup and may also position tab arm 12a against an interior wall portion of the cup.

FIG. 23 illustrates a top view of another exemplary configuration of an embodiment of a folding filtered contamination containment device, in accordance with an embodiment of the present invention, wherein a user may secure the filter holder and the filter inside of the cup by pressing down on score line 16 to position the filter holder inside cup 30a and thus also possibly securing tab arms 12a, 18a and 18b against cup interior wall 39a

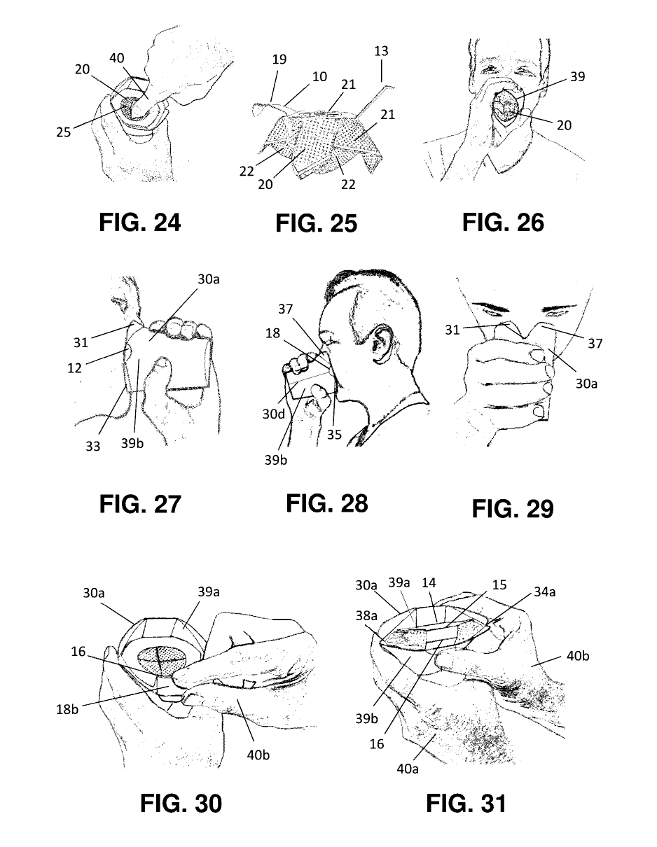

FIG. 24 illustrates a top view of another exemplary configuration of an embodiment of a folding filtered contamination containment device, in accordance with an embodiment of the present invention, wherein a user finger 40 may be placed into a filter opening 25 to possibly expand an inside of filter 20.

FIG. 25 illustrates a side view of an exemplary configuration of exemplary filter and exemplary filter holder, in accordance with an embodiment of the present invention, wherein filter 20 may be joined to filter holder 10, furthermore filter top layer 21 may extend away from filter bottom layer 22 when a user's finger may be placed into a filter opening to possibly expand an inside of filter 20.

FIG. 26 illustrates a front perspective view of an exemplary application of an exemplary folding filtered contamination containment device embodiment, in accordance with an embodiment of the present invention, wherein filter 20 and cup bottom edge 39 may be in a parallel orientation with respect to a user's face when used to cover a cough and or sneeze. FIG. 27 illustrates a right perspective view of an exemplary application of an exemplary folding filtered contamination containment device embodiment, in accordance with an embodiment of the present invention, wherein an interior portion of right nose foldout 31 and an interior portion of right chin foldout 33 may be pressed against user's face as the user holds cup 30a to the user's face. Furthermore, right tab 12 may be fixedly joined to an exterior cup wall 39b to aid in keep a filter holder joined to cup 30a. FIG. 28 illustrates a left perspective view of an cup exemplary application of an exemplary folding filtered contamination containment device embodiment, in accordance with an embodiment of the present invention, wherein an interior portion of left nose foldout 37 and interior portion of left chin foldout 35 may be pressed against user's face as the user holds a cup of folding filtered contamination containment device to the user's face. Furthermore, left tab 18 may be fixedly joined to outside edge 39d to aid in keep a filter holder joined to the cup. FIG. 29 illustrates a top perspective view of an exemplary application of an exemplary folding filtered contamination containment device embodiment, in accordance with an embodiment of the present invention, wherein an interior portion of left nose foldout 37 and an interior portion of right nose foldout 31 may be pressed against user's face as the user holds cup 30a to the user's face.

FIG. 30 illustrates a top view of an exemplary configuration of an embodiment of a folding filtered contamination containment device, in accordance with an embodiment of the present invention, wherein a user may lift up of a portion of a filter holder while possibly exerting inward pressure on a wall of cup 30a. A user's right hand 40b may pull score line 16 and left tab 18b away from cup interior wall 39a to begin a reconfiguration of cup 30a.

FIG. 31 illustrates a top view of another exemplary configuration of an embodiment of a folding filtered contamination containment device, in accordance with an embodiment of the present invention, wherein a user may exert inward pressure on a wall of cup 30a during a reconfiguration of the cup. The user's left hand 40a and right hand 40b may release pressure on score lines 34a and 38a while left hand 40a and right hand 40b may simultaneously apply inward pressure on cup exterior wall 39b, furthermore, score line 14 may remain inside cup 30a and may remain pressed against cup interior wall 39a, while score lines 15 and 16 may be forced to extend outside cup 30a.

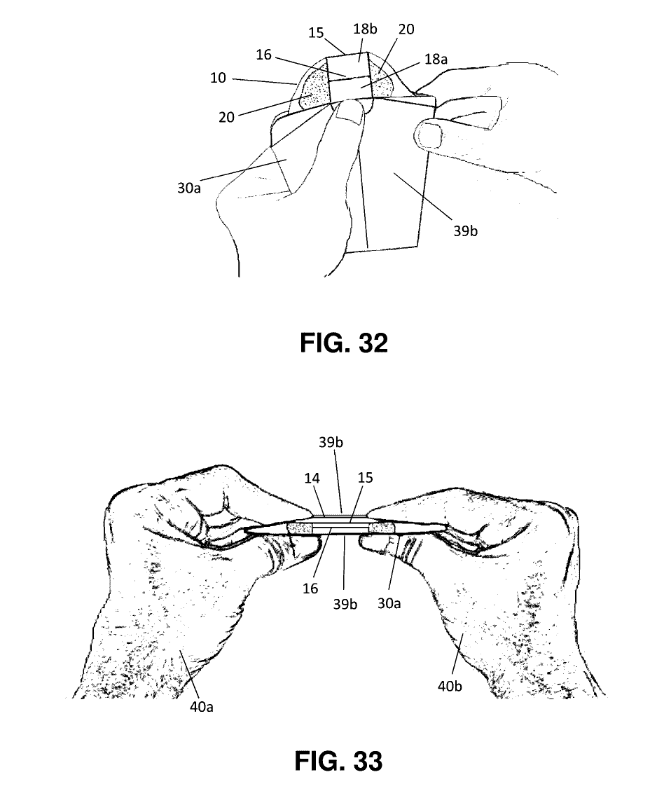

FIG. 32 illustrates a side view of another exemplary configuration of an embodiment of a folding filtered contamination containment device, in accordance with an embodiment of the present invention, wherein a reconfigured cup may include a portion of a filter and a portion of a filter holder that remain inside the reconfigured cup. In the present embodiment the reconfigured cup may be a folded cup, wherein cup 30a may be reconfigured as a folded cup by a user's left hand 40a and right hand 40b possibly applying pressure to cup exterior wall 39b while score line 16 and tab arms 18a and 18b may be are pressed against an upper portion of filter 20 and an upper portion of filter holder 10 while a lower portion of filter 20 and a lower portion of filter 10 may remain inside cup 30a.

FIG. 33 illustrates a top view of an exemplary closed configuration of an embodiment of a folding filtered contamination containment device, in accordance with an embodiment of the present invention, wherein a reconfigured cup may include a portion of a filter and a portion of a filter holder that remain inside the reconfigured cup. In the present embodiment, the reconfigured cup may be a folded cup, wherein cup 30a may be reconfigured as a folded cup by a user's left hand 40a and right hand 40b possibly applying inward pressure to cup exterior wall 39b while score line 14 may remain inside cup 30a while score lines 15 and 16 extend away from and outside of cup 30a as also shown in FIG. 32. In another embodiment of the present invention a filter holder may be redesigned, adding multiple foldout portions and tabs to secure a filter holder to a cup. In other embodiments, a filter holder and cup may be constructed of alternate materials such as, but not limited to, paper, plastic or some other suitable material.

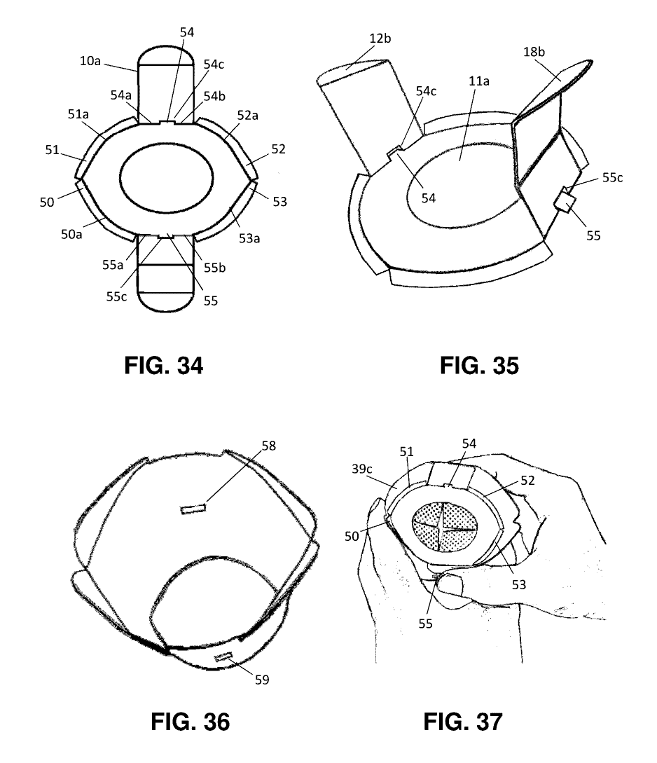

FIG. 34 illustrates a top view of an exemplary embodiment of a filter holder 10a, in accordance with an embodiment of the present invention, wherein the filter holder may include a multiplicity of foldouts and die cut tabs. In the present embodiment, filter holder 10a may include a multiplicity of foldouts 50, 51, 52 and 53 and die cut tabs 54 and 55, in accordance with an embodiment of the present invention. Filter holder 10a may further include score lines 50a, 51a, 52a, 53a, 54a, 54b, 55a and 55b and die cut lines 54c and 55c. In the present embodiment, score lines 50a, 51a, 52a, 53a, 54a, 54b, 55a and 55b may be cut on the top of filter holder 10a.

FIG. 35 is an oblique view of an exemplary configuration of an exemplary embodiment of a filter holder, in accordance with an embodiment of the present invention, wherein the filter holder may be configured to include a right tab 12b and a left tab 18b possibly extending upward away from filter holder opening 11a and further possibly exposing die cut tabs 54 and 55 and die cut lines 54c and 55c.

FIG. 36 is a top view of an exemplary embodiment of a cup of a folding contamination containment device, in accordance with an embodiment of the present invention, wherein the cup may include cup wall openings 58 and 59.

FIG. 37 illustrates a top view of an exemplary configuration of an exemplary embodiment of a folding contamination containment device, in accordance with an embodiment of the present invention, wherein a filter holder may be inserted into cup wall openings and furthermore bottom portions of filter holder foldouts may be pressed against an interior wall of a cup with edges of the foldouts facing upward away from a filter. In the present embodiment, bottom portions of foldouts 50, 51, 52 and 53 may be positioned flat against a cup interior wall 39c and furthermore, die cut tabs 54 and 55 may be inserted into cup wall openings 58 and 59.

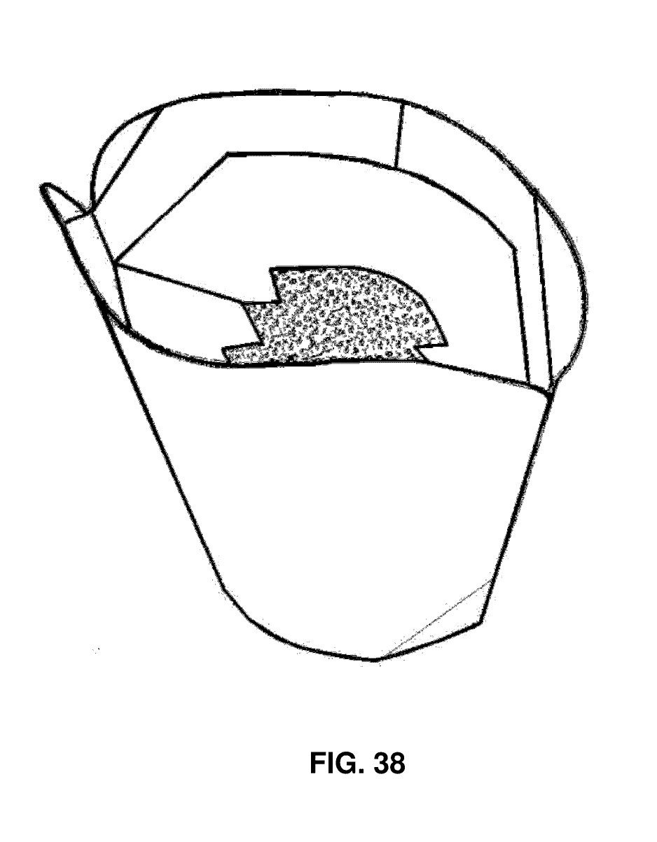

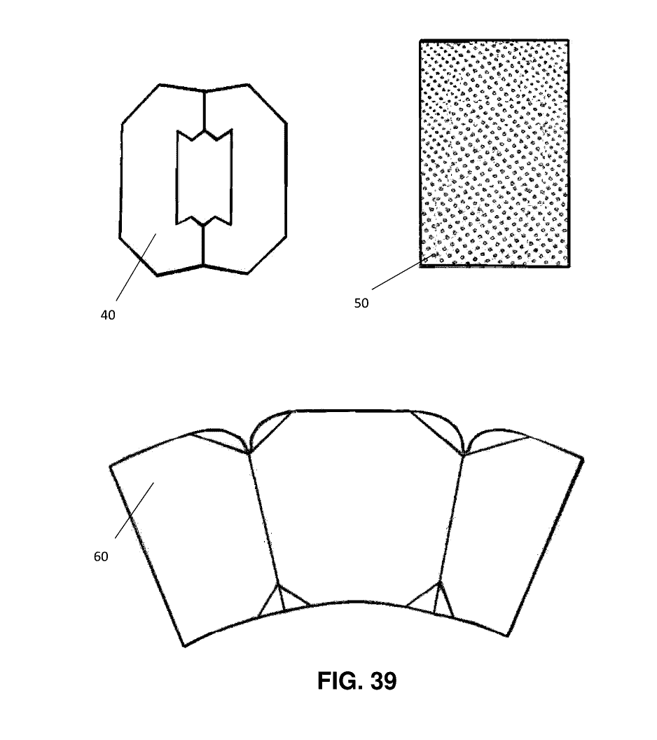

FIG. 38 illustrates an exemplary view of another exemplary embodiment of a folding filtered contamination containment device, in accordance with an embodiment of the present invention. In the present embodiment a folding filtered contamination containment device may be configured to include a filter holder, a filter and a cup, wherein a user may hold the cup to the user's face and cough and/or sneeze into cup. In many embodiments the folding filtered contamination containment device may be configured to be disposable. In some other embodiments the folding filtered contamination containment device may be configured to be reusable and/or washable. FIG. 39 illustrates exemplary components of an exemplary embodiment of a folding filtered contamination containment device, in accordance with an embodiment of the present invention. In the present embodiment, the folding filtered contamination containment device may include a filter holder 40, a filter 50, and a cup blank 50. The components may be comprised of a multiplicity of materials such as, and without limitation, paper, plastic, nonwoven fabrics, cotton, gauze, activated charcoal, cellulose acetate fiber, Styrofoam™, chipboard wherein filter holder 40 may be constructed of substantially any durable material that may be imprinted with advertisements or logos, such as, and without limitation, paper, plastic, etc. Filter 50 may be constructed of any durable, flexible material such as, and without limitation, nonwoven fabric. Furthermore, cup blank 60 may be constructed of any durable material that can be imprinted with advertisements or logos, such as, but not limited to, paper, plastic, etc. In many embodiments of the present invention, filter holder 40 may be comprised of 14-point chipboard. Furthermore, filter 50 may include a top layer, middle layer and bottom layer of 100% nonwoven polypropylene fabric. In many embodiments, the middle layer of filter 50, may further include a meltblown nonwoven layer, with a weight class of 23 gsm, between a top layer and bottom layer of spunbond nonwoven fabric each with a weight class of 15 gsm. The total weight class of filter 50 may be 53 gsm. In many embodiments, filter 50 may be comprised of a preferred range of 1 ply to 6 ply material. In many embodiments of the present invention, filter 50 may be comprised of a preferred total weight class of 20 gsm to 100 gsm. In many embodiments, cup blank 60 may be comprised of 12-point chipboard and may also be formed into a cup like shape. However, alternate filter weights may be suitable depending upon the needs of the particular application.

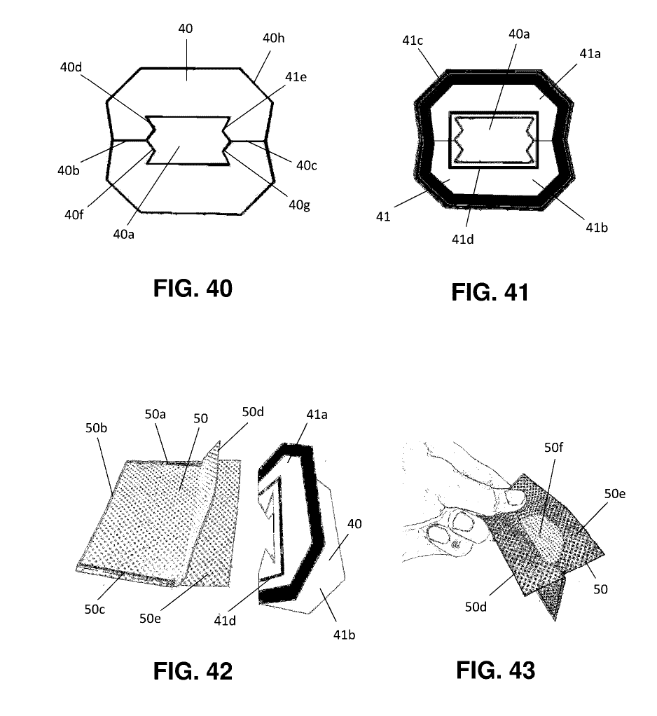

FIG. 40 illustrates a top cross-sectional view of an exemplary filter holder 40 of an exemplary folding filtered contamination containment device embodiment, in accordance with an embodiment of the present invention. In the present embodiment, filter holder 40 may include an opening 40a, score lines 40b and 40c, gable lines 40d, 40e, 40f, 40g and a perimeter edge line 40h. Score lines 40b and 40c are used to fold filter holder 40 as shown in FIG. 42. In the present embodiment gable lines 40d, 40e, 40f and 40g may be used to reinforce the stiffness and strength of a material of filter holder 40 when the device may be held open.

FIG. 41 illustrates a bottom view of an exemplary embodiment of a filter holder, in accordance with an embodiment of the present invention, wherein portions of a bottom of the filter holder may be covered with adhesive. In the present embodiment the filter holder may include bottom halves 41a and 41b, adhesive 41c, adhesive 41d and opening 40a, wherein adhesive 41c may be used to join the filter holder to an interior cup wall of a cup. However, alternate means of joining the filter holder to the interior cup wall of the cup may be suitable depending upon the needs of the particular application.

FIG. 42 illustrates a side view of an exemplary configuration of an exemplary filter 50 and an exemplary filter holder 40, in accordance with an embodiment of the present invention. In the present embodiment, filter 50 may include weld seams 50a, 50b and 50c, filter flaps 50d and 50e, an adhesive 41c and adhesive 41d, wherein filter 50, as shown in FIG. 39, may be folded in half and then may be heat welded at weld seams 50a, 50b and 50c to possibly form filter pocket 50f. Remaining, un welded material of filter 50 may form filter flaps 50d and 50e, wherein the filter flaps may be joined to filter holder 40 using adhesive 41d. Filter holder 40 may be positioned between filter flaps 50d and 50e. However, alternate embodiments may be configured depending upon the needs of the particular application.

FIG. 43 illustrated a top view of an exemplary configuration of an exemplary filter 50, in accordance with an embodiment of the present invention, wherein filter 50 may include a recessed portion. In the present embodiment filter 50 may include filter flaps 50d, 50e and filter pocket 50f, wherein the recessed portion may be filter pocket 50f. The filter pocket may be formed by welding only seams of layers of filter 50.

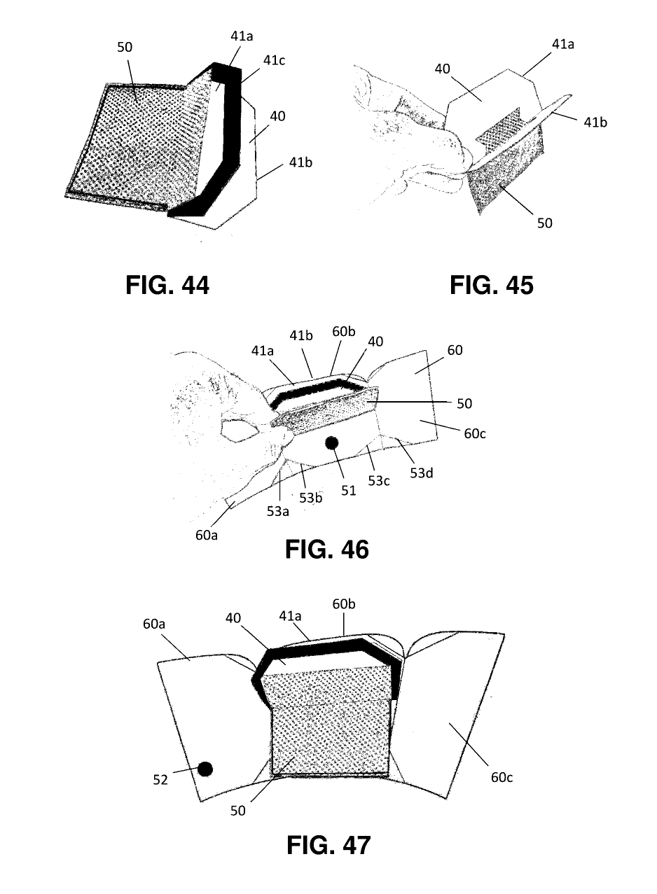

FIG. 44 illustrates a side view of an exemplary configuration of an exemplary filter 40 and an exemplary filter holder 50, in accordance with an embodiment of the present invention, wherein the filter may be joined to a bottom portion of the filter holder.

FIG. 45 illustrates a top view of an exemplary configuration of an exemplary filter 40 and an exemplary filter holder 50, in accordance with an embodiment of the present invention, wherein the filter may be joined to a bottom portion of the filter holder, furthermore, filter holder 50 may be held by a user.

FIG. 46 illustrates an exemplary interior view of a folding filtered contamination containment device embodiment, in accordance with an embodiment of the present invention, wherein the folding filtered contamination containment device embodiment may include an adhesive 51 on an interior portion of cup blank 60 and an adhesive on a portion of filter holder. In the present embodiment, the folding filtered contamination containment device may include a filter holder 40, a filter 50 a filter holder half 41b, a blank interior wall 60b, cup blank 60, and score lines 53a, 53b, 53c and 53d, wherein the portion of filter holder may be filter holder half 41b. Furthermore, in the present embodiment, filter 50 may be fixedly joined filter holder 40 and filter holder half 41b may be fixedly joined to blank interior wall 60b of the cup blank. Moreover, adhesive 51 may be fixedly joined to a lower portion of blank interior wall 60b, wherein adhesive 51 may keep filter 50 from moving upward in a case that a user inhales. However, alternate embodiments may be configured depending upon the needs of the particular application.

FIG. 47 illustrates another exemplary interior view of a folding filtered contamination containment device embodiment, in accordance with an embodiment of the present invention, wherein the device may include an adhesive on a portion of an interior wall of a cup blank and an adhesive on a portion of a filter holder. In the present embodiment, cup blank 60 and filter 50 may be fixedly joined to filter holder 40. Furthermore, filter holder half 41a may be fixedly joined to blank interior wall 60b. In the present embodiment, an adhesive 52 may be fixedly joined to a lower portion of blank interior wall 60a, wherein adhesive 52 may be used to keep filter 50 from moving upward in a case that a user may inhale while using the device. However, alternate embodiments may be configured depending upon the needs of the particular application.

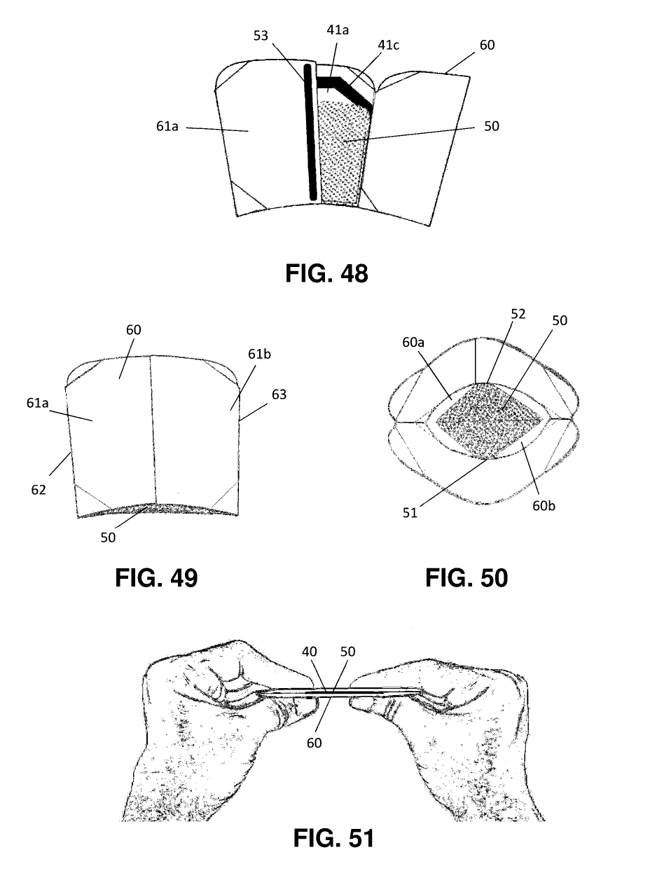

FIG. 48 illustrates a side view of an exemplary configuration of a folding filtered contamination containment device embodiment, in accordance with an embodiment of the present invention, wherein a portion of an exemplary cup blank 60 may folded over a portion of exemplary filter 50 and folded over a portion of an exemplary filter holder. In the present embodiment, the device may further include a blank exterior wall 61a, a filter holder half 41a, and an adhesive 53, wherein, blank exterior wall 61a of cup blank 60 may be folded over a portion of filter holder half 41a and a portion of filter 50. Furthermore, adhesive 53 may be used to seal together blank exterior wall 61a and another exterior wall of cup blank 60. However, alternate embodiments may be configured depending upon the needs of the particular application.

FIG. 49 illustrates a side view of an exemplary closed configuration of a folding filtered contamination containment device embodiment, in accordance with an embodiment of the present invention, wherein a folded exemplary cup blank may include an interior comprising an exemplary filter and an exemplary filter holder. In the present embodiment the device may include a cup blank 60, fold lines 62 and 63 and blank exterior walls 61a and 61b, wherein cup blank 60 may be configured to enclose the exemplary filter and the exemplary filter holder with blank exterior walls 61a and 61b by possibly folding the walls closed at fold lines 62 and 63.

FIG. 50 illustrates a bottom view of an exemplary open configuration of a folding filtered contamination containment device embodiment, in accordance with an embodiment of the present invention, wherein a filter may be fixedly joined to cup walls. In the present embodiment, portions of filter 50 may be fixedly joined to adhesive 51 and 52, (shown in FIG. 46 and FIG. 47). Furthermore, lower portions of filter 50 may be held in place to blank interior walls 60a and 60b. However, alternate embodiments may be configured depending upon the needs of the particular application.

FIG. 51 illustrates a top view of an exemplary closed configuration of a folding filtered contamination containment device embodiment, in accordance with an embodiment of the present invention, wherein a closed folded cup may be held by a user. In the present embodiment, the folding filtered contamination containment device may be reconfigured to minimize space occupation, and thus be pocket, wallet, and/or handbag sized. In the present embodiment, cup blank 60 may be held by a user, wherein the cup blank, prior to being opened, comprise filter holder 40 and filter 50 inside of cup blank 60.

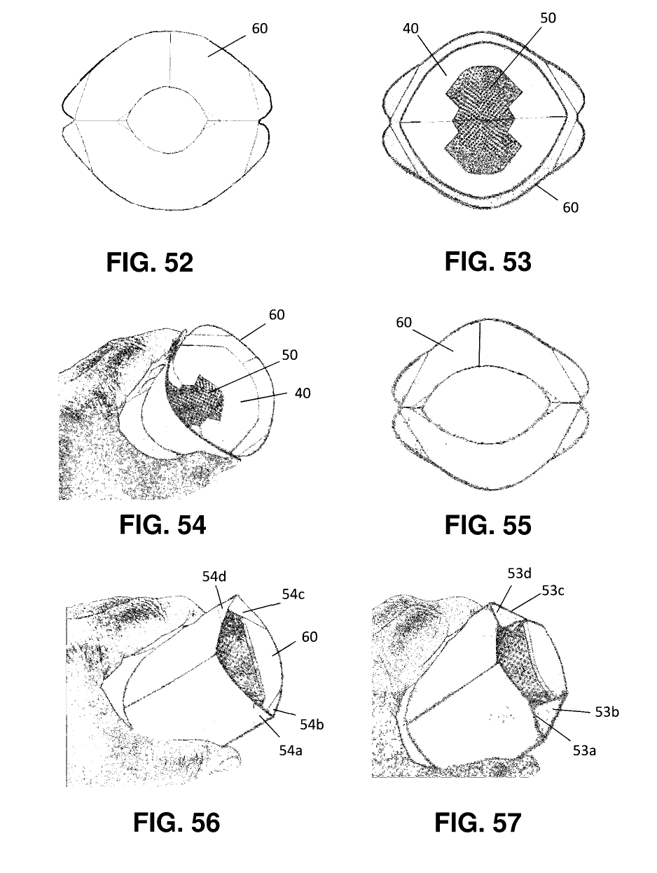

FIG. 52 illustrates a top view of an exemplary cup configuration of a folding filtered contamination containment device embodiment, in accordance with an embodiment of the present invention, wherein the cup configuration may include a cup top opening and cup bottom opening. In the present embodiment, a cup blank 60 may be unfolded prior to inserting a filter holder and/or a filter, wherein the unfolded cup blank may include a cup top opening and a cup bottom opening. Furthermore, cup top opening may be adjustable and approximately oval in shape.

FIG. 53 illustrates an exemplary top view of an exemplary embodiment of a folding filtered contamination containment device, in accordance with an embodiment of the present invention, wherein the device may include a cup blank, filter, and filter holder. In the present embodiment the device may be configured to include filter holder 40 joined to filter 50 and filter holder 40 joined to an interior wall of cup blank 60.

FIG. 54 illustrates an exemplary top view of a user holding an exemplary embodiment of a folding filtered contamination containment device, in accordance with an embodiment of the present invention, where, the user may unfold a cup blank 60 of the folding filtered contamination containment device. In the present embodiment, the user may unfold the cup blank by presses their thumb and fingers inward against fold lines 62 and 63 (as shown in FIG. 49). Furthermore, filter holder 40 may create a V-shape with a bottom of the “V”-shape pointed downward when the folding filtered contamination containment device may be unfolded and ready for use.

FIG. 55 illustrates an exemplary bottom view of an exemplary cup of a folding filtered contamination containment device embodiment, in accordance with an embodiment of the present invention, wherein the cup configuration may include a cup top opening and cup bottom opening. In the present embodiment, a cup blank 60 may be unfolded prior to inserting a filter holder and/or a filter, wherein the unfolded cup blank may include a cup top opening and a cup bottom opening. Furthermore, cup top bottom may generally be smaller than cup top opening.

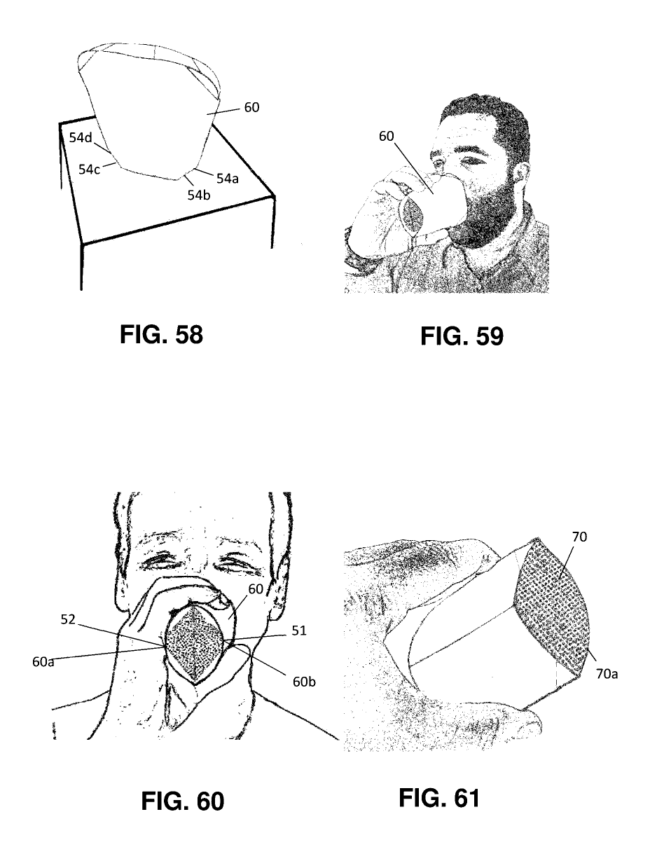

FIG. 56 illustrates a bottom view of an exemplary cup configuration of a folding filtered contamination containment device embodiment, in accordance with an embodiment of the present invention. In the present embodiment, the folding filtered contamination containment device may include cup blank 60, wherein the cup blank may further include bottom cup tabs 54a, 54b, 54c and 54d. FIG. 57 illustrates a bottom view of another exemplary cup configuration of a folding filtered contamination containment device embodiment, in accordance with an embodiment of the present invention, wherein, cup blank 60 bottom cup tabs 54a, 54b, 54c and 54d may be folded inward along score lines 53a, 53b, 54c and 53d. Furthermore, the cup tabs may provide a means for cup blank 60 to stand upright. However, alternate embodiments may be configured depending upon the needs of the particular application. FIG. 58 illustrates an exemplary application of an embodiment of a folding filtered contamination containment device embodiment, in accordance with an embodiment of the present invention, wherein cup blank 60 may be configured to form an upright standing structure. In the present embodiment, for example, and without limitation, the blank cup may be configured to stand upright on a table, or substantially, any other surface. Furthermore, in the present embodiment cup blank 60 may be unfolded sitting upright on a table by folding cup tabs 54a, 54b, 54c and 54d inward as shown in FIG. 57.

FIG. 59 illustrates a left perspective view of an exemplary application of an exemplary folding filtered contamination containment device embodiment, in accordance with an embodiment of the present invention, wherein a user may hold cup blank 60 of the folding filtered contamination containment device to his/her face, and may cover his/nose and mouth in a case that the user may have to cough and/or sneeze.

FIG. 60 illustrates a front perspective view of an exemplary application of an exemplary folding filtered contamination containment device embodiment, in accordance with an embodiment of the present invention, wherein cup blank 60 may be held by a user and adhesives 51 and 52 may hold filter 50 to interior cup walls 60a and 60b so that the filter may stay in place in a case that the user may inhale while the device may be in use. However, alternate embodiments may be configured depending upon the needs of the particular application.

FIG. 61 illustrates a bottom view of another embodiment of a folding filtered contamination containment device embodiment, in accordance with an embodiment of the present invention, wherein an exemplary folding filtered contamination containment device may include a bottom filter in accordance with an embodiment of the present invention. In the present embodiment, the bottom filter may be a second filter, wherein the bottom filter may be joined to a bottom of a blank cup of the folding filtered contamination containment device, a bottom filter 70 may be joined to a bottom rim perimeter 70a of cup blank. However, alternate embodiments may be made depending upon the needs of the particular application. The second filter may be a secondary filter used in conjunction with a primary filter such as, and without limitation, filter 50 as shown in FIG. 53, and thus using both primary and secondary filters may provide dual filtration. In some alternative embodiments a multiplicity of filters may be joined to interior walls of a blank cup.

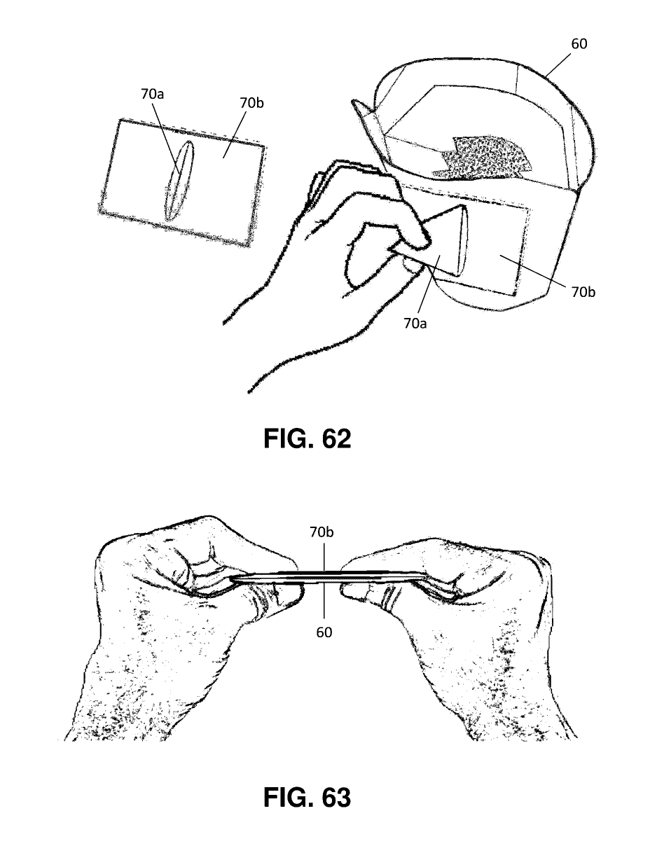

FIG. 62 illustrates another exemplary application of another embodiment of an exemplary folding filtered contamination containment device, in accordance with an embodiment of the present invention, wherein an exemplary tissue and tissue dispenser may be used in conjunction with an exemplary folding filtered contamination containment device. In the present embodiment, the device may include a tissue dispenser 70b and a tissues, wherein tissue dispenser 70b may be joined to a side of cup blank 60, and the tissue dispenser may include an opening for a user to pull out a tissue 70a. In other embodiments, tissue dispenser may be positioned inside cup blank 60. In an alternative embodiment the tissue dispenser may dispense antibacterial tissues/wipes. However, alternate embodiments may be configured depending upon the needs of the particular application.

FIG. 63 illustrates a top view of an exemplary closed configuration of another embodiment of a folding filtered contamination containment device, in accordance with an embodiment of the present invention, wherein the folding filtered contamination containment device may include a filter and a filter holder inside a blank cup and a tissue and a tissue holder on the outside of the blank cup. In the present embodiment, a tissue dispenser 70b may be joined to an exterior surface of cup blank 60.

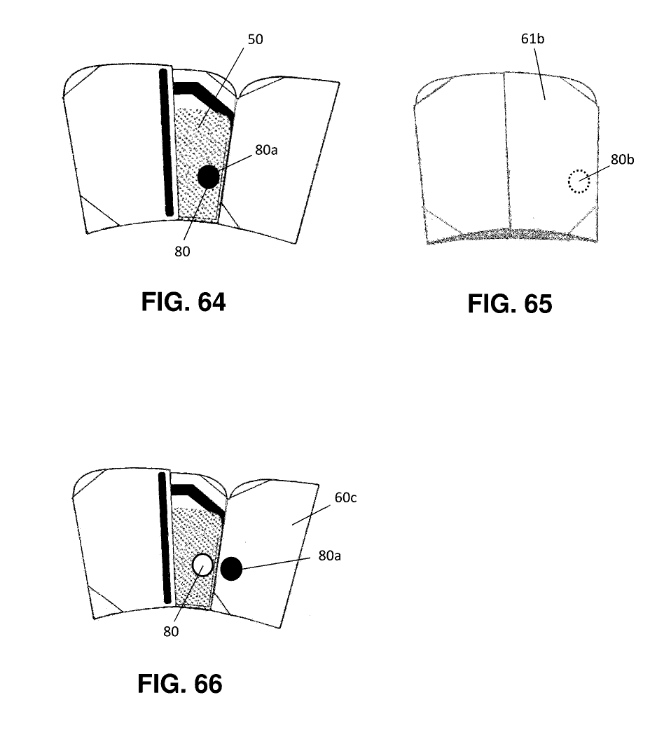

FIG. 64 illustrates a side interior view of a configuration of another embodiment of a folding filtered contamination containment device, in accordance with an embodiment of the present invention, wherein the folding filtered contamination containment device may include a scent tab. In some present embodiment, a scent cover portion may be joined to the top of the scent tab and the scent tab may be joined to a filter. Furthermore, a bottom of the scent tab may have an adhesive side that may hold the sent tab to the filter. A top and bottom of a cover tab may be covered with adhesive. Moreover, potentially pressing an area of an exterior wall of a blank cup may cause an adhesive top layer of the cover tab to join to an interior wall of the blank cup and thus may release the cover tab from the scent tab. In the present embodiment, a cover tab 80a may be joined to a scent tab 80 and scent tab 80 may also be joined to filter 50. Furthermore, cover tab 80a may comprise a top adhesive layer and a bottom adhesive layer. In many embodiments, a user may uncover scent tab 80 by the user applying pressure to an external area of a blank cup. However, alternate embodiments may be made depending upon the needs of the particular application. FIG. 65 illustrates a side view of an exemplary closed configuration of another embodiment of a folding filtered contamination containment device, in accordance with an embodiment of the present invention, wherein, the external area of the blank cup may be area 80b. In the present embodiment, area 80b may be located on exterior wall 61b. A user may press on area 80b which may cause an interior wall 61b to press against the top adhesive layer of cover tab 80a. Cover tab 80a may be removed from scent tab 80 when a user may remove pressure to area 80b.

FIG. 66 illustrates a side interior view of another configuration of a folding filtered contamination containment device embodiment, in accordance with an embodiment of the present invention, wherein the device, may further include a scent tab and a cover tab. In the present embodiment, scent tab 80 may be joined to filter 50 and cover tab 80a may be joined to interior wall 60c, wherein scent may be released when the scent tab may be uncovered according to an embodiment of the present invention. However, alternate embodiments may be made depending upon the needs of the particular application.

As will be described in some detail below, with particular reference to FIG. 12 through FIG. 26, in many embodiments of the present invention, an application of a folding filtered contamination containment device as described and illustrated above may begin with a user potentially joining filter 20 to an adhesive side of filter holder 10. Next four corners of the filter 20 may be folded toward a center of filter 20. Then, score line 13 may be positioned at to right tab rest 32. Right tab 12 may then be joined may be joined to a top of an exterior wall portion of cup 30a. Next, the user may lower filter holder 10 and filter 20 into cup 30a, wherein the user may hold cup 30a with one hand and also hold left tab 18, with another hand to guide filter 20 into cup 30a by guiding left tab 18 toward left tab rest 36. Then, the user may join left tab 18 to exterior cup wall 39b via left tab rest 36, wherein the joining may include bending filter holder 10 at score line 17. Filter holder 10 may be placed inside cup 30a, wherein a right arm portion of the filter holder may be towards cup interior wall 39a and score line 17 may be positioned on top of left tab rest 36. Afterwards, the user may press down on score line 15 to possibly position the filter holder inside cup 30a. Next, the user may press down on score line 16 to further possibly position the filter holder inside the cup and may also position tab arm 12a against an interior wall portion of the cup. Then the user may secure the filter holder and the filter inside of the cup by further pressing down on score line 16 and thus also possibly securing tab arms 12a, 18a and 18b against cup interior wall 39a. After that, the user may use a finger to poke into a filter die cut slit 25 to possibly expand an inside of filter 20. In a case that the user may need to sneeze and/or cough, the user may lift the device to his/her face so that the user's nose and mouth may fit into a top opening of the cup. The user may then cough, sneeze, breath, or any combination thereof before lowering the device. The lifting and lowering may be repeated as needed.

As will be described in some detail below, with particular reference to FIG. 49, FIG. 54 and FIG. 59, in many embodiments of the present invention, an application of a folding filtered contamination containment device as described and illustrated above may begin with a user potentially applying inward pressure at to score line 62 and 63 thus opening top and bottom of cup 60. In a case that the user may need to sneeze and/or cough, the user may lift the device to his/her face so that the user's nose and mouth may fit into a top opening of the cup. The user may then cough, sneeze, breath, or any combination thereof before lowering the device. The lifting and lowering may be repeated as needed.

All the features disclosed in this specification, including any accompanying abstract and drawings, may be replaced by alternative features serving the same, equivalent or similar purpose, unless expressly stated otherwise. Thus, unless expressly stated otherwise, each feature disclosed is one example only of a generic series of equivalent or similar features.

Those skilled in the art will readily recognize, in light of and in accordance with the teachings of the present invention, that any of the foregoing steps may be suitably replaced, reordered, removed and additional steps may be inserted depending upon the needs of the particular application. Moreover, the prescribed method steps of the foregoing embodiments may be implemented using any physical and/or hardware system that those skilled in the art will readily know is suitable in light of the foregoing teachings. For any method steps described in the present application that can be carried out on a computing machine, a typical computer system can, when appropriately configured or designed, serve as a computer system in which those aspects of the invention may be embodied.

It is noted that according to USA law 35 USC §112 (1), all claims must be supported by sufficient disclosure in the present patent specification, and any material known to those skilled in the art need not be explicitly disclosed. However, 35 USC §112 (6) requires that structures corresponding to functional limitations interpreted under 35 USC §112 (6) must be explicitly disclosed in the patent specification. Moreover, the USPTO's Examination policy of initially treating and searching prior art under the broadest interpretation of a “mean for” claim limitation implies that the broadest initial search on 112(6) functional limitation would have to be conducted to support a legally valid Examination on that USPTO policy for broadest interpretation of “mean for” claims. Accordingly, the USPTO will have discovered a multiplicity of prior art documents including disclosure of specific structures and elements which are suitable to act as corresponding structures to satisfy all functional limitations in the below claims that are interpreted under 35 USC §112 (6) when such corresponding structures are not explicitly disclosed in the foregoing patent specification. Therefore, for any invention element(s)/structure(s) corresponding to functional claim limitation(s), in the below claims interpreted under 35 USC §112 (6), which is/are not explicitly disclosed in the foregoing patent specification, yet do exist in the patent and/or non-patent documents found during the course of USPTO searching, Applicant(s) incorporate all such functionally corresponding structures and related enabling material herein by reference for the purpose of providing explicit structures that implement the functional means claimed. Applicant(s) request(s) that fact finders during any claims construction proceedings and/or examination of patent allowability properly identify and incorporate only the portions of each of these documents discovered during the broadest interpretation search of 35 USC §112 (6) limitation, which exist in at least one of the patent and/or non-patent documents found during the course of normal USPTO searching and or supplied to the USPTO during prosecution. Applicant(s) also incorporate by reference the bibliographic citation information to identify all such documents comprising functionally corresponding structures and related enabling material as listed in any PTO Form-892 or likewise any information disclosure statements (IDS) entered into the present patent application by the USPTO or Applicant(s) or any 3^{rd} parties. Applicant(s) also reserve its right to later amend the present application to explicitly include citations to such documents and/or explicitly include the functionally corresponding structures which were incorporate by reference above.

Thus, for any invention element(s)/structure(s) corresponding to functional claim limitation(s), in the below claims, that are interpreted under 35 USC §112 (6), which is/are not explicitly disclosed in the foregoing patent specification, Applicant(s) have explicitly prescribed which documents and material to include the otherwise missing disclosure, and have prescribed exactly which portions of such patent and/or non-patent documents should be incorporated by such reference for the purpose of satisfying the disclosure requirements of 35 USC §112 (6). Applicant(s) note that all the identified documents above which are incorporated by reference to satisfy 35 USC §112 (6) necessarily have a filing and/or publication date prior to that of the instant application, and thus are valid prior documents to incorporated by reference in the instant application.

Having fully described at least one embodiment of the present invention, other equivalent or alternative methods of implementing a contamination containment device according to the present invention will be apparent to those skilled in the art. Various aspects of the invention have been described above by way of illustration, and the specific embodiments disclosed are not intended to limit the invention to the particular forms disclosed. The particular implementation of the contamination containment device may vary depending upon the particular context or application. By way of example, and not limitation, the contamination containment device described in the foregoing were principally directed to a handheld, collapsible, air filtering device implementations; however, similar techniques may instead be applied to wearable air filtration devices, gas masks, and disease detection devices which implementations of the present invention are contemplated as within the scope of the present invention. The invention is thus to cover all modifications, equivalents, and alternatives falling within the spirit and scope of the following claims. It is to be further understood that not all of the disclosed embodiments in the foregoing specification will necessarily satisfy or achieve each of the objects, advantages, or improvements described in the foregoing specification.

Claim elements and steps herein may have been numbered and/or lettered solely as an aid in readability and understanding. Any such numbering and lettering in itself is not intended to and should not be taken to indicate the ordering of elements and/or steps in the claims.

The corresponding structures, materials, acts, and equivalents of all means or step plus function elements in the claims below are intended to include any structure, material, or act for performing the function in combination with other claimed elements as specifically claimed.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

The Abstract is provided to comply with 37 C.F.R. Section 1.72(b) requiring an abstract that will allow the reader to ascertain the nature and gist of the technical disclosure. That is, the Abstract is provided merely to introduce certain concepts and not to identify any key or essential features of the claimed subject matter. It is submitted with the understanding that it will not be used to limit or interpret the scope or meaning of the claims.

The following claims are hereby incorporated into the detailed description, with each claim standing on its own as a separate embodiment.

What is claimed is:

1. A device comprising a folding filtered contamination containment device may include:
a filter holder
a filter and a cup
wherein a user may hold the cup to the user's face and cough or sneeze into cup. The cup being configured to be disposable or reusable and washable.
